(19) United States
(12) Patent Application Publication
(10) Pub. No.: US 2016/0208783 A1
(43) Pub. Date: Jul. 21, 2016

(54) PRESSURE RELIEF SYSTEM AND METHOD IN AN ENERGY RECOVERY DEVICE

(71) Applicant: Exergyn Ltd., Dublin (IE)

(72) Inventors: Barry CULLEN, Dublin (IE); Ronan BYRNE, Dublin (IE)

(21) Appl. No.: 14/898,198

(22) PCT Filed: Jun. 13, 2014
(86) PCT No.: PCT/EP2014/062443

§ 371 Date: Dec. 14, 2015

(30) Foreign Application Priority Data
Jun. 13, 2013 (GB) 1310512.7

(51) Int. Cl. F03G 7/06

(52) U.S. Cl. CPC F03G 7/065

(57) ABSTRACT

The application provides a number of embodiments for an energy recovery device incorporating a SMA core or material. This application solves the problem of pressure pulsing caused by a volume reduction which is a result of the contraction of SMA core and its coupled piston head within a closed immersed chamber. The application disclosed provides a number of effective solutions of removing this issue with minimal additional components.

### FIELD OF THE INVENTION

The present application relates to the field of energy recovery and in particular to the use of shape memory alloys (SMA) for same.

### BACKGROUND TO THE INVENTION

Low grade heat, which is typically considered less than 100 degrees, represents a significant waste energy stream in industrial processes, power generation and transport applications. Recovery and re-use of such waste streams is desirable. An example of a technology which has been proposed for this purpose is a Thermoelectric Generator (TEG). Unfortunately, TEG's are relatively expensive. Another largely experimental approach that has been proposed to recover such energy is the use of Shape Memory Alloys.

A shape-memory alloy (SMA) is an alloy that “remembers” its original, cold-forged shape which once deformed returns to its pre-deformed shape upon heating. This material is a lightweight, solid-state alternative to conventional actuators such as hydraulic, pneumatic, and motor-based systems.

The three main types of shape-memory alloys are the copper-zinc-aluminium-nickel, copper-aluminium-nickel, and nickel-titanium (NiTi) alloys but SMAs can also be created, for example, by alloying zinc, copper, gold and iron.

The memory of such materials has been employed or proposed since the early 1970's for use in heat recovery processes and in particular by constructing SMA engines which recover energy from heat as motion.

In a first type, referred to as a crank engine, of which U.S. Pat. No. 468,372 is an example, convert the reciprocating linear motion of an SMA actuator into continuous rotary motion, by eccentrically connecting the actuator to the output shaft. The actuators are often trained to form extension springs. Some configurations require a flywheel to drive the crank through the mechanism's limit positions. A related type are Swash Plate Engines, which are similar to cranks except that their axis of rotation is roughly parallel to the direction of the applied force, instead of perpendicular as for cranks.

A second type are referred to as a pulley engines, an example of which is U.S. Pat. No. 4,010,612. In pulley engines, continuous belts of SMA wire is used as the driving mechanism. A pulley engine may be unsynchronized or synchronized. In unsynchronized engines, the pulleys are free to rotate independently of one another. The only link between different elements is rolling contact with the wire loops. In contrast, in synchronized engines, the pulleys are constrained such that they rotate in a fixed relationship. Synchronization is commonly used to ensure that two shafts turn at the same speed or keep the same relative orientation.

A third type of SMA engine may be referred to as field engines, an example of which is U.S. Pat. No. 4,027,479. In this category, the engines work against a force, such as a gravitational or magnetic field.

A fourth type of SMA engine is that of Reciprocating Engines of which U.S. Pat. No. 4,434,618 in an example. These reciprocating engines operate linearly, in a back-and-forth fashion, as opposed to cyclically.

A fifth type of SMA engine is that of Sequential Engines of which U.S. Pat. No. 4,938,026 is an example. Sequential engines move with small, powerful steps, which sum to substantial displacements.

They work like an inchworm, extending the front part by a small step and then pulling the back part along. With the back part nearby, the front part can extend again.

A sixth type of SMA engine is shown in U.S. Pat. No. 5,150,770, assigned to Contraves Italiana S.p.A., and discloses a spring operated recharge device. There are two problems with the Contraves device, namely it is difficult to recharge quickly in a reciprocating manner and secondly it is difficult to discharge the energy to a transmission system without losses occuring.

A seventh type of SMA engine is shown in US patent publication number US2007/261307A1, assigned to Breezway Australia Pty Limited, and discloses an energy recovery charge system for automated window system. Breezway discloses a SMA wire that is coupled to a piston which is used to pump fluid to a pressurised accumulator. The piston therefore moves in tandem with the SMA wire as it contracts and expands. By coupling the SMA wire to the piston in this manner, the SMA wire is in indirect communication with the energy accumulator via the pumped fluid which is ineffiecient and the Breezway system suffers from the same problems as Contraves.

An eight type of SMA engine is shown in US patent publication number US2008/0034749, assgined to General Motors Corporation, and discloses an active material acutator with modulated movement.

In addition one of the difficulties with each of these types of SMA engines has been that of the cycle period of the SMA material. SMA material is generally relatively slow to expand and contract (10's of RPM). It has been and remains difficult to achieve a worthwhile reciprocating frequency that might be usefully employed in an industrial application (100's to 1000's of RPM). This is not a trivial task and generally is complicated and involves significant parasitic power losses. Another problem within the devices is due to the reciprocating movement of the SMA material results causing a pressure differential, or pressure pulsing, to accrue in the device such that contraction of a heating core and the full expansion of the cooling core are hindered.

The present application is directed to solving at least one of the above mentioned problems.

### SUMMARY OF THE INVENTION

### Fluid Transfer Pressure Relief Embodiment

This invention solves the problem of pressure pulsing caused by a volume reduction which is a result of the contraction of SMA wire and its coupled piston head within a closed immersed chamber. The invention disclosed offers a simple effective method of removing this issue with minimal additional components.

In one embodiment an energy recovery device comprising:
a SMA engine comprising a length of SMA material fixed at a first end and connected at a second end to a drive mechanism;
an immersion chamber adapted for housing the SMA engine and adapted to be sequentially filled with fluid to allow heating and/or cooling of the SMA engine;
a second SMA engine comprising a length of SMA material fixed at a first end and connected at a second end to a drive mechanism;
a second immersion chamber adapted for housing the SMA engine and adapted to be sequentially filled with fluid to allow heating and/or cooling of the SMA engine; wherein the first and second core are in fluid communication with each other.

In another embodiment there is provided an energy recovery device comprising:
a first SMA core housed in a first immersion chamber and adapted to be sequentially filled with fluid to allow heating and/or cooling of the first SMA core;
a second SMA core housed in a second immersion chamber and adapted to be sequentially filled with fluid to allow heating and/or cooling of the second SMA core; and
wherein the first and second core are in fluid communication with each other.

It will be appreciated that it is also possible to have more than one core connected, such that the displaced mass of water is passed to multiple adjacent cylinders.

The system allows for the passing fluid mass between adjacent cylinders for the purpose of simultaneously enabling full, unhindered contraction of a heating core and the full expansion of the cooling core, assisted by the additional mass passed over from the heating core.

### Hydraulic Pressure Relief Embodiment

In one embodiment there is provided an energy recovery device comprising:
a SMA core housed in an immersion chamber and adapted to be sequentially filled with fluid to allow heating and/or cooling of the SMA core; and
the immersion chamber is configured with an additional chamber comprising a biasing means, such as a spring, wherein on the SMA core expanding in said chamber the biasing means allows fluid to flow into the additional chamber.

In one embodiment the biasing means comprises a hydraulic piston.

This invention solves the problem of pressure pulsing caused by a volume reduction which is a result of the contraction of SMA wire and its coupled piston head within a closed immersed chamber. The invention disclosed offers a simple effective method of removing this issue with minimal additional components.

The invention also provides a method of producing work from the pressure pulse. This could either contribute to the output power of the system or to operate a valve train or otherwise provide useful additional power. Either of these options will contribute to an increase in the efficiency of the system.

### Regenerator Fluid Exchange Embodiment

In one embodiment there is provided an energy recovery device comprising:
a SMA engine comprising a length of SMA material fixed at a first end and connected at a second end to a drive mechanism;
an immersion chamber adapted for housing the SMA engine and adapted to be sequentially filled with fluid to allow heating and/or cooling of the SMA engine;
a second SMA engine comprising a length of SMA material fixed at a first end and connected at a second end to a drive mechanism;
a second immersion chamber adapted for housing the SMA engine and adapted to be sequentially filled with fluid to allow heating and/or cooling of the SMA engine; wherein the first and second cores are in fluid communication via a regenerative heat exchanger.

The regenerative heat exchanger permits the storage of heat from the transiting water that may be utilised later in the cycle. This heat may be collected by the water as it returns through the regenerator later in the cycle. In this manner, efficiency of the engine is improved.

This invention permits the offsetting of undesirable pressure pulsing in the SMA core heat engine concept whilst also permitting the maximum usage of wasted heat through the use of a regenerative heat exchanger between working cores.

### Volume Exchange Pressure Relief Embodiment

In one embodiment there is provided an energy recovery device comprising:
a SMA engine comprising a length of SMA material fixed at a first end and connected at a second end to a drive mechanism;
an immersion chamber adapted for housing the SMA engine and adapted to be sequentially filled with fluid to allow heating and/or cooling of the SMA engine;
a second SMA engine comprising a length of SMA material fixed at a first end and connected at a second end to a drive mechanism;
a second immersion chamber adapted for housing the SMA engine and adapted to be sequentially filled with fluid to allow heating and/or cooling of the SMA engine; wherein the first and second cores are in fluid communication via an adjoining piston or hydraulic line.

This invention solves the problem of pressure pulsing caused by a volume reduction which is a result of the contraction of SMA wire and its coupled piston head within a closed immersed chamber. The invention disclosed offers a simple effective method of removing this issue with minimal additional components.

The system of the invention allows for cores to interact with each other, by permitting the heating cores to pass on their volumetric displacements to those which are cooling. This operation results in assisting in lowering the piston in the cooling core, thereby reducing the required relaxation force used to perform this conventionally.

### Mechanical Volume Exchange Embodiment

In one embodiment there is provided an energy recovery device comprising:
a SMA engine comprising a length of SMA material fixed at a first end and connected at a second end to a drive mechanism;
an immersion chamber adapted for housing the SMA engine and adapted to be sequentially filled with fluid to allow heating and/or cooling of the SMA engine;
a second SMA engine comprising a length of SMA material fixed at a first end and connected at a second end to a drive mechanism;
a second immersion chamber adapted for housing the SMA engine and adapted to be sequentially filled with fluid to allow heating and/or cooling of the SMA engine; wherein a constant volume in each core is maintained through a piston connection between the first and second cores.

In one embodiment the movement of the piston is controlled by a mechanical linkage between it and a working piston.

The invention also removes issues associated with attempting to solve the pressure pulsing issue using hydraulic linkages through the working fluid. These methods will share the pressure pulse with other pressure vessels in the system, which may not be capable of withstanding rapid pressure variations. The mechanical linkage method does not incorporate these issues, as it will maintain a constant volume at all times.

This invention also reduces the required inventory when compared with pressure relief methods whereby each individual core contains a mechanism which allows for pressure regulation independent of other cores in the system. Therefore, this represents an advantage for the mechanical volumetric exchange concept over these approaches, as it will require one pressure relief mechanism for every two cores in the system.

In one embodiment the system is adapted to partition the fluid within coupled cores, preventing mixing of hot and cold fluid flows. This offers an advantage over other methods which require an exchange of fluid to take place, as the mixing of fluid with different temperatures may have a negative effect on the operation of the SMA components contained within cores. An example of this may be a cold flow entering a heating core, where this cold flow would reduce the temperature in the core and thereby increase the time required to fully contract the SMA wire contained within said core.

### Piston Shaft Pressure Relief Embodiment

In one embodiment there is provided an energy recovery device comprising:
a SMA core housed in an immersion chamber and adapted to be sequentially filled with fluid to allow heating and/or cooling of the SMA core; and
the SMA core is linked with a moveable piston in the chamber;
wherein the piston is configured with a shaft that has a same Cross Sectional Area (CSA) that will displace the same combined volume of the linear and/or radial contractions of the SMA over the length of one expansion or contraction.

This invention solves the problem of pressure pulsing caused by a volume reduction which is a result of the contraction of SMA wire and its coupled piston head within a closed immersed chamber. The invention disclosed offers a simple effective method of removing this issue with minimal additional components.

A typical solution to this issue is to implement pressure vessels, which represent additional components and cost to the system. By using the shaft of the piston, which is required to be present in the arrangement, the need for these additional components is removed or reduced.

### Mechanical Pressure Relief Embodiment

In one embodiment there is provided an energy recovery device comprising:
a SMA core housed in an immersion chamber and adapted to be sequentially filled with fluid to allow heating and/or cooling of the SMA core; and
the SMA core is linked with a moveable first piston in the chamber;
a second piston adapted to operate in a non-synchronous manner with the first piston.

This invention solves the problem of pressure pulsing caused by a volume reduction which is a result of the contraction of SMA wire and its coupled piston head within a closed immersed chamber. The invention disclosed offers a simple effective method of removing this issue with minimal additional components.

The invention also removes issues associated with attempting to solve the pressure pulsing issue using hydraulic linkages through the working fluid. These methods will merely share the pressure pulse with other pressure vessels in the system, which may not be capable of withstanding rapid pressure variations. The mechanical linkage method does not incorporate these issues.

### BRIEF DESCRIPTION OF THE DRAWINGS

The invention will be more clearly understood from the following description of an embodiment thereof, given by way of example only, with reference to the accompanying drawings, in which:—

FIG. 1 illustrates how volume reduction in a core can be achieved;

FIG. 2 illustrates a two core fluid transfer pressure relief schematic, according to one embodiment of the invention;

FIG. 3 illustrates a multiple core fluid transfer pressure relief schematic, similar to FIG. 2;

FIG. 4 illustrates operation of a spring resisted pressure relief mechanism during (a) cooling, and (b) heating;

FIG. 5 illustrates operation of alternate piston/spring arrangement during (a) cooling, and (b) heating;

FIG. 6 illustrates a piston and pressure relief piston according to one embodiment;

FIG. 7 show states of a compression spring's operation;

FIG. 8 illustrates friction present in piston housing during operation, (a) as the piston lowers during cooling, the opposing frictional forces can be seen to be acting in an opposing fashion (F_{H}), and (b) the same can be seen during SMA contraction;

FIG. 9 illustrates operation of power producing hydraulic element during (a) cooling, and (b) heating;

FIG. 10 illustrates a transmission for pressure relief;

FIG. 11 illustrates a pressure relief transmission assembly for a four core system;

FIG. 12 illustrates a four core pressure relief transmission without belts;

FIG. 13 illustrates the location of required piston return force, according to one embodiment;

FIG. 14 illustrates a schematic of a pressure relief system according to one embodiment of the invention;

FIG. 15 illustrates operation of self-assisting piston using separate hydraulic line, (a) as the SMA cools, the main and assisting pistons descend, causing the hydraulic pistons to rise, (b) the SMA contracts as it is heated, which results in the main and assisting pistons rising, pushing the hydraulic pistons downward;

FIG. 16 illustrates SMA wire contractions (left), and basic geometries of housing (right);

FIGS. 17 & 18 illustrates dimensional operation of pressure relief concept B during (a) cooling and (b) heating;

FIG. 19 illustrates a schematic of a pressure relief system according to one embodiment of the invention;

FIG. 20 illustrates an embodiment of the fluid exchange concept implementing a buffer core;

FIG. 21 shows heating flow cycle of an individual core, (a) core is fully cooled and about to start heating, (b) core begins heating as cold inlet is closed, and the hot inlet opened, while cold fluid is still flowing (flushed) through the cold outlet, and (c) core fills with hot fluid and the hot outlet is opened, while the working piston continues to rise;

FIG. 22 illustrates operation of a regenerator, according to one embodiment;

FIG. 23 illustrates the Temperature vs time curve for regenerator in the Drive application according to one embodiment;

FIG. 24 illustrates two Pressure Relief Configurations;

FIG. 25 illustrates Pressure Relief Operation, (a) As core A heats, it passes its displaced volume onto core B, (b) As core B heats, it passes its displaced volume onto core A;

FIG. 26 illustrates operation of five core system with disparate heating & cooling cycles, where a red core represents a heating core and blue represents a cooling core;

FIG. 27 illustrates piston displacements for simultaneously heating & cooling cores;

FIG. 28 illustrates volumetric variation during one heating cooling cycle for single core;

FIG. 29 illustrates volumetric changes of multiple cores;

FIG. 30 illustrates pressure relief operation for three core system, (a) heated core C “exchanges” volume with cores A and B, (b) heated core A “exchanges” volume with cores B and C, (c) heated core B “exchanges” volume with cores A and C;

FIG. 31 illustrates heating/cooling sequence for five core system;

FIG. 32 illustrates core cycling through pressure relief operation;

FIG. 33 illustrates operation of pressure relief for alternate system arrangement;

FIG. 34 illustrates core cycling through pressure relief operation;

FIG. 35 illustrates operation of piston pressure relief in parallel;

FIG. 36 illustrates a compounding frictional force example;

FIG. 37 illustrates hydraulic Piston dimensions in use;

FIG. 38 illustrates a pressure relief set-up, according to one embodiment;

FIG. 39 illustrates a piston pressure relief schematic, according to one embodiment;

FIG. 40 illustrates operation of a mechanically linked volume exchange pressure relief, (a) After core A has cooled and prepared to begin heating, (b) as core A heats, it “passes on” volume to core B, which is cooling;

FIG. 41 illustrates an embodiment of mechanical volumetric exchange concept through core outlets;

FIG. 42 illustrates volumetric displacements which occur in device operation during (a) cooling, and (b) heating of core A, while the opposite displacements simultaneously occur in core B;

FIG. 43 illustrates a piston (1) & rod (2 & 3) seal locations;

FIG. 44 illustrates Mechanical Volumetric Exchange Schematic according to one embodiment;

FIG. 45 illustrates Multiple Volumetric Changes;

FIG. 46 illustrates SMA wire & piston areas;

FIG. 47 illustrates SMA wire contractions;

FIG. 48 illustrates stresses present in pressure relief components;

FIG. 49 illustrates resistive frictional force;

FIG. 50 illustrates an embodiment of a seal used with a piston according to one embodiment;

FIG. 51 illustrates pressure relief using hinge as mechanical linkage during (a) cooling, and (b) heating;

FIG. 52 illustrates operation of self-assisting piston using working fluid during (a) cooling and (b) heating;

FIG. 53 illustrates SMA wire contractions (left), and basic geometries of housing (right).

FIG. 54 illustrates operation of pressure relief concept implementing output transmission when (a) cooling, and (b) heating;

FIG. 55 illustrates transmission for pressure relief according to one embodiment.

FIG. 56 illustrates states of a compression spring's operation.

FIG. 57 illustrates location of required piston return force; and

FIGS. 58, 59 & 60 illustrates schematics of alternative embodiments of the present invention.

### DETAILED DESCRIPTION OF THE DRAWINGS

A shape memory alloy (SMA) actuator to recover and convert low grade heat to mechanical work is described in unpublished PCT patent application number PCT/EP2012/074566, assigned to Exergyn Limited, and incorporated herein fully by reference.

It will be appreciated that while SMA material/core is substantially described herein with respect to the Figures, the invention can be applied to a class of materials more generally known as ‘active material’ or Negative Thermal Expansion (NTE) materials. NTE materials include those compositions that can exhibit a change in stiffness properties, shape and/or dimensions in response to an activation signal, which can be an electrical, magnetic, thermal or a like field depending on the different types of active materials. Preferred active materials include but are not limited to the class of shape memory materials, and combinations thereof. Shape memory materials, a class of active or NTE materials, also sometimes referred to as smart materials, refer to materials or compositions that have the ability to remember their original shape, which can subsequently be recalled by applying an external stimulus (i.e., an activation signal).

### Fluid Transfer Pressure Relief Embodiment

An issue with SMA activated energy recovery devices is pressure pulsing. This pulse is caused by a change in volume of the system due to the movement of a working piston connected to Shape Memory Alloy (SMA) wire. This volume variance is significant as it alters the pressure in the system

$$( P ∝ \frac{1}{V} )$$

where an incompressible fluid (water) is present. This results in large pressure changes, which may cause the system to fail. It is therefore required that a solution to this issue be defined.

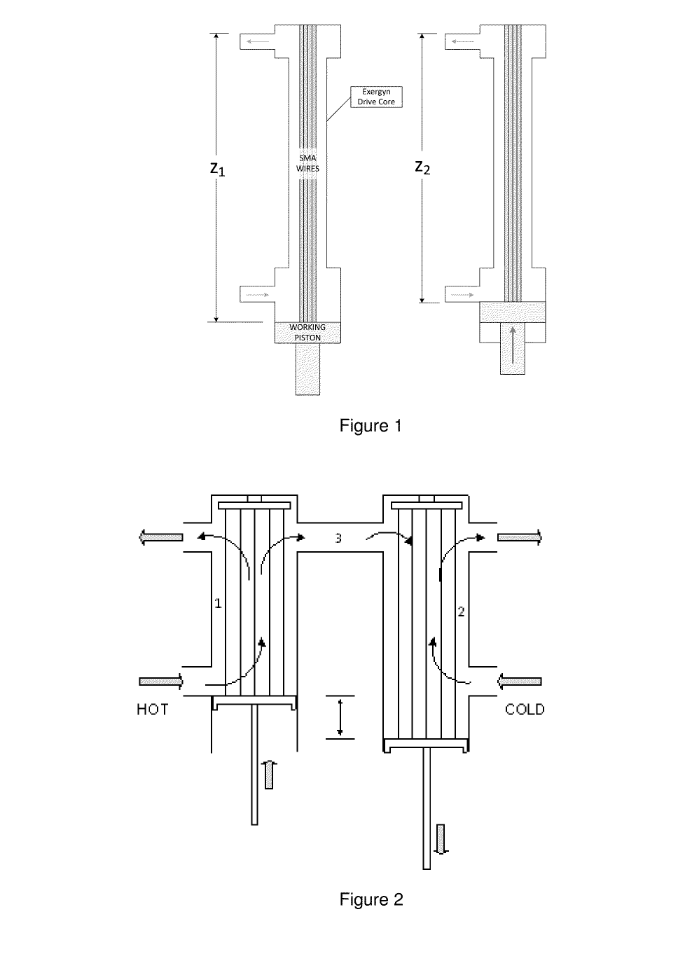

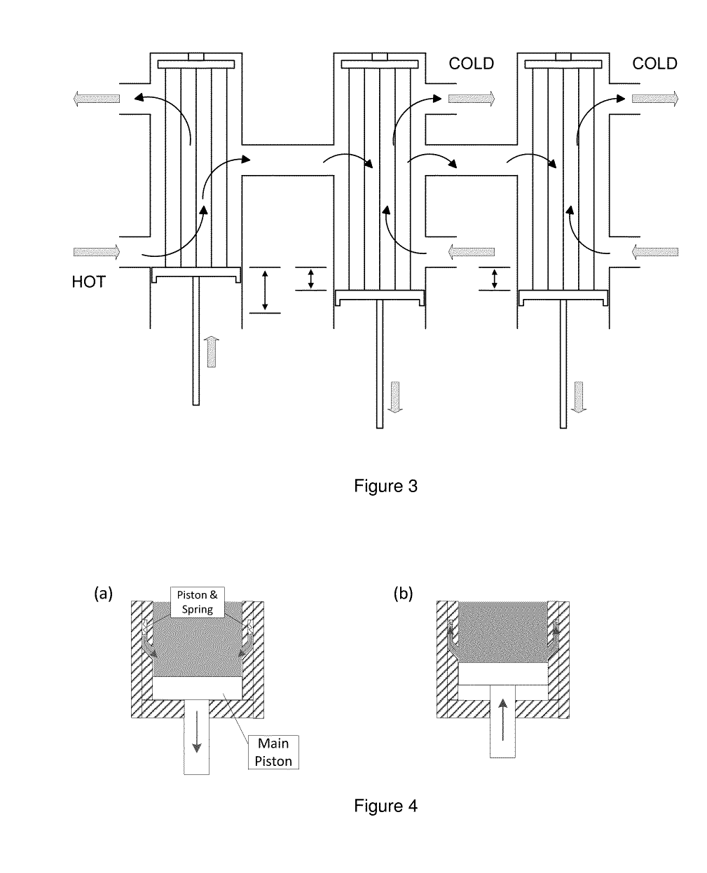

The pulsing issue arises from a volumetric change caused by the movement of the working piston in the system cores. During the operation of these cores a working fluid is passed over SMA bundles. This fluid is sequentially altered between hot and cold flows, and induces a phase change in the SMA components. When heated, the SMA component contracts, lifting the connected piston and thereby causing a reduction of volume in the system. FIG. 1 illustrates this operation. It can be seen that as the piston rises, the distance from the head of the piston to the core outlet is reduced from z₁ to z₂, which in turn reduces the volume.

The present invention overcomes the undesirable pressure pulsing involving the connection of a plurality of working cores such that the fluid chambers are in direct communication with each other, enabling transfer of volume by means of fluid mass exchange between them. This is shown in FIG. 2.

In the simplest embodiment of the system, two cores 1, 2 are connected such that the fluid chambers are in direct communication with each other via a channel or connection 3. At any given moment, one core is heated (i.e. a hot fluid is passed through the chamber, immersing the SMA element in the process, causing it to heat and contract) and the other is cooled (i.e. a cool fluid is passed through the second chamber, immersing the SMA element therein and causing it to cool and expand).

It will be understood that, as the SMA working element is heated, it contracts, lifting the working piston and thus—in the absence of any adjusting mechanism—causes a reduction in the total chamber volume. Because the fluid is assumed in this instance to be a liquid and therefore incompressible, the system pressure is caused to rise as a result.

Simultaneously, the adjacent core is cooling, resulting in the SMA element expanding back to an original starting length and volume (Note that due to the Bain strain, the volume of the SMA material reduces upon heating).

As the core cools, a negative pressure can arise in the system if the volume is allowed increase without a corresponding intake of fluid.

This fluid mass may be supplied by the main intake, that is from the system inlet. However, this implies a momentary increase in system volume flowrate if system pressure is to be maintained. More probably, a negative pressure spike will be encountered.

Also, during the heating stage, the displaced volume of fluid would lead to a momentary increase of mass flowrate from the system, which is unlikely to be possible.

A means by which to accommodate these displaced masses is to connect the adjacent cores via the channel 3. Therefore, as one core 1 heats, it displaces a volume of fluid to the second core 2, which may accept the fluid as a means by which to maintain system pressure.

It will be understood that there are a number of system variables that must be accounted for. Perhaps the most relevant is the possibility of there existing a disparity in the heating and cooling times of the SMA elements in the adjacent cores. This would imply that the instantaneous fluid volume displaced from the heating core and that required in the cooling core are not equal and therefore the full pressure-relief effect would not be felt.

The way in which to overcome this is to connect a number of cores in such a way that excess fluid volume displaced during a heating stroke may be divided among a number of cores. This enables full system pressure to be maintained. The ratio of the number of cores to be connected (i.e. ratio of cooling cores to heating cores) would be dictated directly by the ratio of the heating and cooling times, thus:

N_{c}=rₜNₕ

Where N_{c} is the number of cooling cores, Nₕ the number of heating cores and rₜ is the ratio of cooling to heating times t_{c}/tₕ.

It may also be appreciated that the ratio, rₜ may not always be a direct multiple of 1, such that the implication arises that only fractional-size cores are actually required. A means by which to accommodate this would be to simply dictate that the number of cooling cores is dictated by the next greatest whole number multiple of N_{c}.

For example, were a situation to arise in which rₜ=1.2, then it would be possible to stipulate that N_{c} be rounded up to 6. Whilst the implication is that there is an excess of time made available for the completion of the heating stroke (a fifth more than needed), this set-up would ensure simplicity of construction and sufficiency of time for levelling out the pressure pulses in the system.

It will be understood that by pumping a part of the fluid into the neighbouring core, the contracting core will in effect perform some work on the cooling core, essentially assisting it in its return stroke. This is advantageous, as SMA elements such as this require a relaxation force to return them to their starting position. Whilst it is not anticipated that the fluid transfer would perform all of the work required to provide the necessary relaxation force (which is generally c.20-30% of the rated work capacity of the alloy itself), it does represent an assistive mechanism that could in effect limit the size and capacity of any relaxation mechanism that might otherwise be implemented.

### Hydraulic Pressure Relief Embodiment

As discussed above, the pulsing issue arises from a volumetric change caused by the movement of the working piston in the system cores. During the operation of these cores a working fluid is passed over SMA bundles. This fluid is sequentially altered between hot and cold flows, and induces a phase change in the SMA components. When heated, the SMA component contracts, lifting the connected piston and thereby causing a reduction of volume in the system. FIG. 1 illustrates this operation. It can be seen that as the piston rises, the distance from the head of the piston to the core outlet is reduced from z₁ to z₂, which in turn reduces the volume.

The pressure pulse issue may be solved through the use of mechanisms that are operated by the working fluid. Appropriate alterations allow for mass to be moved about the core in such a way which would facilitate an increase in the volume of the core, which would offset the variation caused by the rising piston.

### Spring Resisted Piston Concept

Below is a nomenclature for this embodiment, which is intended to assist in understanding the concepts of the invention described herein.

| | |
|---|---|
| V | Volume |
| V_{P} | Volume displaced by main piston head |
| V_{H} | Volume displaced by hydraulic piston |
| F | Force |
| Fᵢ | Initial force exerted on spring |
| F_{f} | Final force exerted on spring |
| F_{H} | Opposing Frictional Force |
| F_{P} | Force Exerted by pressure pulse |
| P | Pressure |
| Pᵢ | Initial pressure exerted on pressure relief piston |
| P_{f} | Final force exerted on pressure relief piston |
| x | Displacement or deflection |
| xₕ | Displacement of hydraulic piston |
| xₚ | Displacement of main piston |
| xᵢ | Initial deflection of spring |
| x_{f} | Final/maximum deflection of spring |
| x_{d} | Deflection of spring caused by pressure pulse |
| dₕ | Diameter of pressure relief piston head |
| dₚ | Diameter of main piston head |
| A | Area |
| Aₚ | Area of main piston face |
| Aₕ | Area of pressure relief piston face |
| k | Spring constant |

The use of compression spring resisted pistons within the piston housing (PH) offers a solution to the pressure pulsing issue. These pistons allow volumetric increases and decreases when needed within the core in order to counteract the volumetric changes caused by the ascending and descending main piston head. FIG. 4 illustrates this concept.

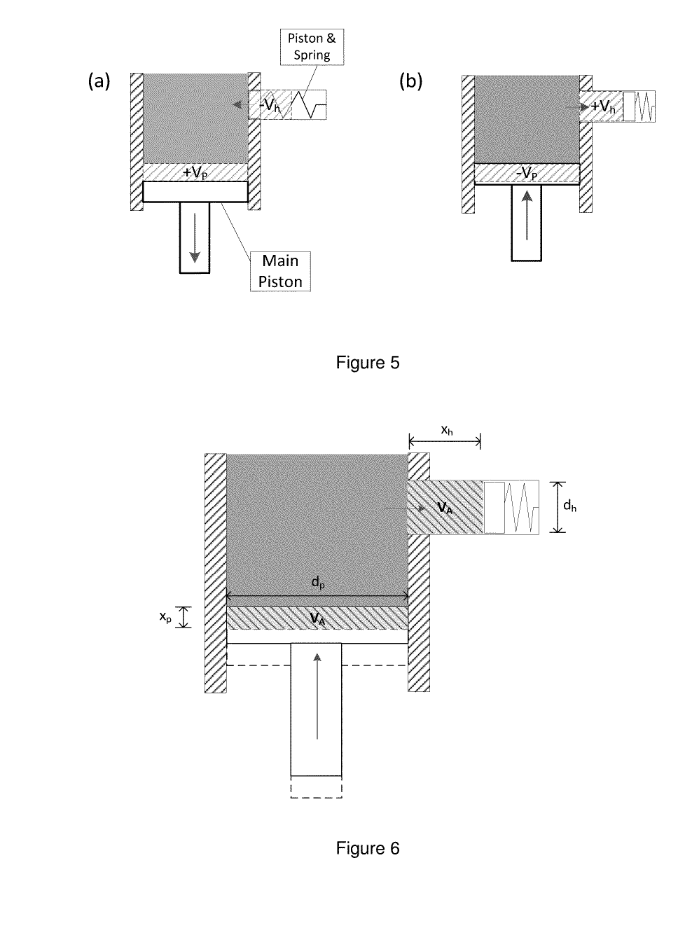

As can be seen in FIG. 4, as the core cools the pressure relief pistons lower maintaining a constant volume in the core. Similarly, as the core heats and causes the main piston to rise, the spring resisted pistons also rise, increasing the volume of the core by the same amount as the reduction caused by the rising piston. This is achieved by transmitting the force created by the pressure pulse through the working fluid to these piston spring arrangements. This is shown in FIG. 5, in an alternative arrangement of this concept, where the piston spring arrangement is placed externally with respect to the core.

It can be seen from FIG. 5 that any volumetric change caused by the main piston (V_{P}) (increases during cooling, and decreases during heating) are countered by the opposite magnitude by the piston and spring (Vₕ). It should be noted that the volume considered to be altered by the main piston is that which occurs after accounting for possible volumetric variations caused by the SMA wires. It can be concluded that in order for the mechanism to remove any pressure increases, these volumes must have the following relationship;

V_{P}=Vₕ

The main factors which must be considered for designing the pressure relief piston head are the Cross Sectional Area (CSA) of the head, and the required level of deflection. Both of these factors will be functions of the deflection and displaced volume of the main SMA actuated piston head. Consider the system shown in FIG. 6.

Firstly, one must determine the value for volume displaced by the main piston head, Vₚ. This is achieved simply, by using the equation for the volume of a cylinder using the piston face area, Aₚ, and its deflection, xₚ;

Vₚ=Aₚxₚ

This will be the volume alteration caused by the rising piston, but does not include the offset volumetric change caused by the SMA wire contraction, which will always be of an opposing magnitude. Hence, the actual volume displaced, V_{A} appear as;

V_{A}=Vₚ−V_{SMA}

Where V_{SMA}=Volume change caused by SMA.

Once again, using the equation for volume of a cylinder, the dimensions of the pressure relief piston head can be calculated, provided either the allowable deflection or piston face diameter of the component is known or desired. This methodology can be applied to designing a piston head for use with the hydraulic line of a motorbike master cylinder, for example. In such a device there is an allowable movement of roughly 10 mm. Assuming the required volume to be displaced is already calculated as discussed above, the following procedure can be followed to determine an appropriate piston face diameter, where the required deflection is known.

$${V}_{A} = {A}_{h} {x}_{h}$$

$${A}_{h} = \frac{{V}_{A}}{{x}_{h}}$$

$$\frac{π {d}_{h}^{2}}{4} = \frac{{V}_{A}}{{x}_{h}}$$

$${d}_{h} = \sqrt{\frac{4 {V}_{A}}{π {x}_{h}}}$$

The values which are input into this equation, either xₕ or dₕ, will be defined by either the allowable movement which the hydraulic piston can move, which may be caused by geometrical constraints, or if its diameter is fixed, which may be the case if standard piston components are to be used. It may also be possible to derive an ideal value for these variables by designing the components so that the effects of friction are reduced.

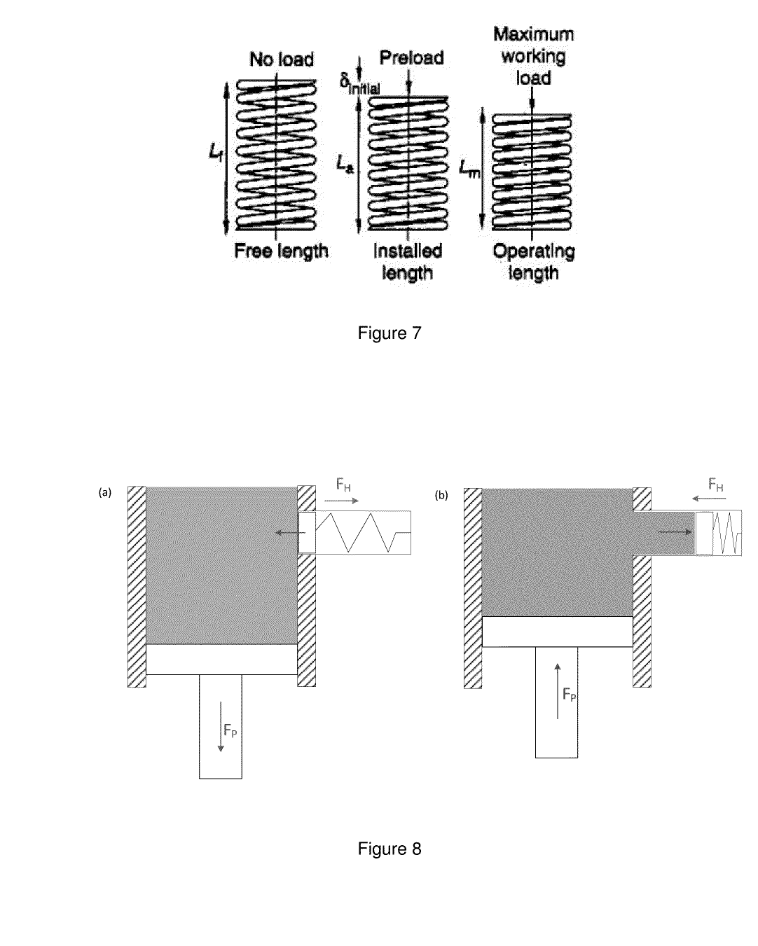

In terms of designing the device, consideration must also be given to the rigidity and geometries of the spring. It has already been discussed how one could size the pressure relief piston based on its allowable deflection. This allowable deflection could be dictated by available space around the cores, if the device were to protrude from said cores. The opposite may be true for the piston face size being constrained by the geometry of the core, in which case the resulting deflections will be calculated in a similar vein. Based off these values, the correct spring may be sized. FIG. 7 illustrates the states of a compression spring in operation.

As can be seen in FIG. 7, the spring will appear in one of three states during operation; free length, preloaded, and maximum working load. The free length is the length of the spring when unloaded, before the Drive is switched on in this application. The installed length, or preload length will be the length of the spring once the drive is turned on. This will be the state at which the spring will be observed to be in when the system is brought up to operational pressure (≈=2 Bar). Finally, under the maximum working load, or the pressure pulse, the spring will reduce to its operational length. This is the length at which the main piston will reach its peak height during heating of the SMA, and the pressure will be greater than before (>2 Bar). Therefore it can be concluded that the total deflection the spring must be capable of facilitating the deflection caused by the initial 2 Bar condition in addition to that caused by the pressure pulse. This can be determined mathematically as follows.

### Example Spring Calculation

Using Hooke's Law it is possible to define the required spring constant which would be used to determine a spring which would allow the required overall deflection which it must undergo. Hooke's Law can be expressed via the equation;

F=−kx

Since the primary function of the spring will be to displace a specific volume based on its piston face surface area, it is necessary determine the correct value for the spring constant (k) based on the piston's required displacement. This can be achieved as follows.
1. Determine the force acting on the piston face at the initial and maximum loading pressures;
   a. Determine the force, Fᵢ, acting on the piston initially caused by system pressure, Pᵢ;

$${P}_{i} = \frac{{F}_{i}}{A}$$

$${F}_{i} = {P}_{i} A$$

b. Determine the force, F_{f}, acting on the piston after the pressure pulse occurs, P_{f};

$${P}_{f} = \frac{{F}_{f}}{A}$$

$${F}_{f} = {P}_{f} A$$

2. Using the values for F_{f} and Fᵢ, use simultaneous equations to determine the required spring stiffness, k, based on Hooke's law;

Fᵢ=−kxᵢ [1]

F_{f}=−kx_{f} [2]
a. Equation 1 can be reduced to;

$$- k = \frac{{F}_{i}}{{x}_{i}}$$

b. Equation 2 can be expressed as follows, where the final deflection, x_{f}, can be expresses as the sum of the initial deflection and deflection caused by the pressure pulse, x_{d};

F_{f}=−k(xᵢ+x_{d})

The expression for k in equation 1 can be subbed into equation 2 in order to determine the initial displacement of the spring, xᵢ. This can then be used to determine the appropriate k value for a spring. After performing this, equation 2 can be reduced to;

$${x}_{i} = \frac{{F}_{f} {x}_{d}}{{F}_{f} - {F}_{i}}$$

3. Using the value for the initial “pre-loaded” deflection, the required spring constant can be found by subbing back in to equation 1.
4. The required spring can now be designed to the spring constant by examining available springs on the market, and determining appropriate spring dimensions for this application giving consideratons to the overall required deflection of the spring.

### Friction Analysis

An issue which may arise during the operation of this method of pressure regulation is that associated with the presence of friction. This is caused by (in relation to the addition of the device itself, not the whole system) the kinetic friction present between the piston and its housing, or more specifically between the piston seal and its housing wall. This frictional force will oppose the movement of the piston in whichever direction it attempts to traverse. However, the pressures and fluctuations which will be present in a drive will be relatively large (>2 Bar), and hence should overcome these frictional forces.

The magnitude of friction will be a function of the diameter of the piston seal. This is due to the fact that the larger the diameter, the larger the contact surface, and greater the frictional force. Therefore, this relationship should be considered when designing said piston in order to reduce the presence of these undesirable forces. FIG. 8 illustrates the frictional forces during operation.

As can be seen, the rising and lowering piston head will produce a force, Fₚ, and the pressure relief piston will produce opposing frictional forces, F_{H}, which will resist movement. Using this illustration, the following can be stated.

The main piston head will overcome the frictional forces if;

F_{P}>F_{H}

Therefore Fₚ must be greater than F_{H} in order to successfully transmit volume to the piston spring arrangement.

The construction of this pressure relief device may require but is not restricted to the following constituents.
1. One piston head per core
2. Seals per piston
3. One compression spring per core
4. One piston/spring housing per core
5. Housing machining for device to attach

### Hydraulic Power

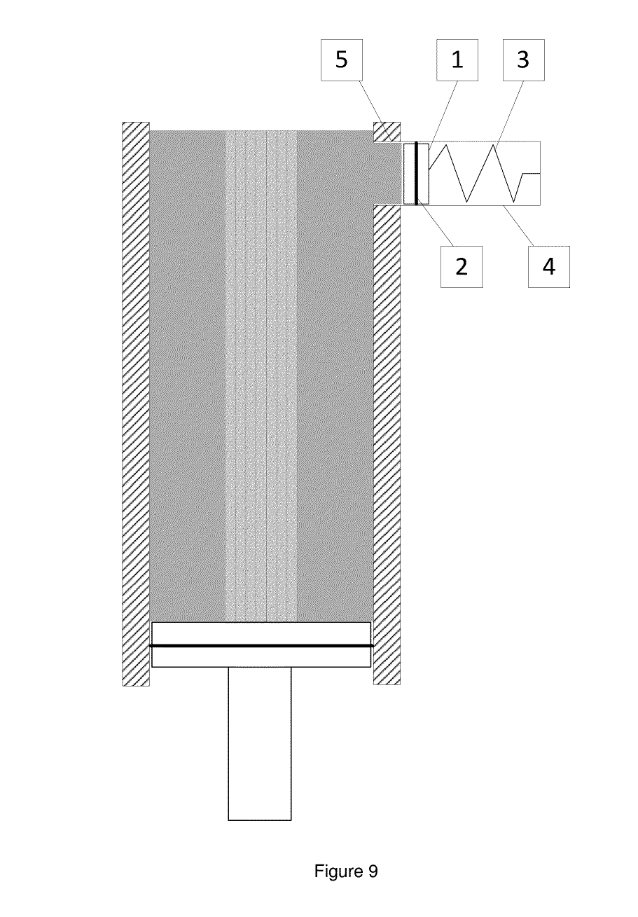

One such arrangement is one in which power is drawn from the pressure pulse. This could be achieved by mating the hydraulic line 4 with a transmission, which could be used for various applications, including contributing to the power output of the system, or operating a valve train. The arrangement consists of a piston 2, a return spring 3, and a transmission 1, as illustrated in FIG. 9.

As can be seen from FIG. 9, as the core heats and its piston rises, the force created pushes the hydraulic piston 2 downwards, and thereby increasing the volume of the system by the appropriate amount. This operation will lead to a constant volume present in the core 5, and hence no pressure pulses are generated. As the core cools, the opposite operation occurs, where the main piston lowers, and the hydraulic pressure relief piston rises due to the presence of the return spring 3, once again maintaining a constant pressure.

It should be noted that the hydraulic piston only does work during the heating phase of the system. When the core is being cooled, the connected transmission component, such as a sprag gear, will freewheel. This will prevent any additional loads resisting movement during this relaxation period. In a system with multiple cores, all of the pressure relief pistons would be connected in series to the same output shaft. This will result in an output pattern similar to that created by the main working piston. This output should be continuous, as the power strokes of the main pistons are intended to overlap one another. Therefore, the output associated with the pressure pulse would be suitable to be used to contribute to the main power output, or to operate valves.

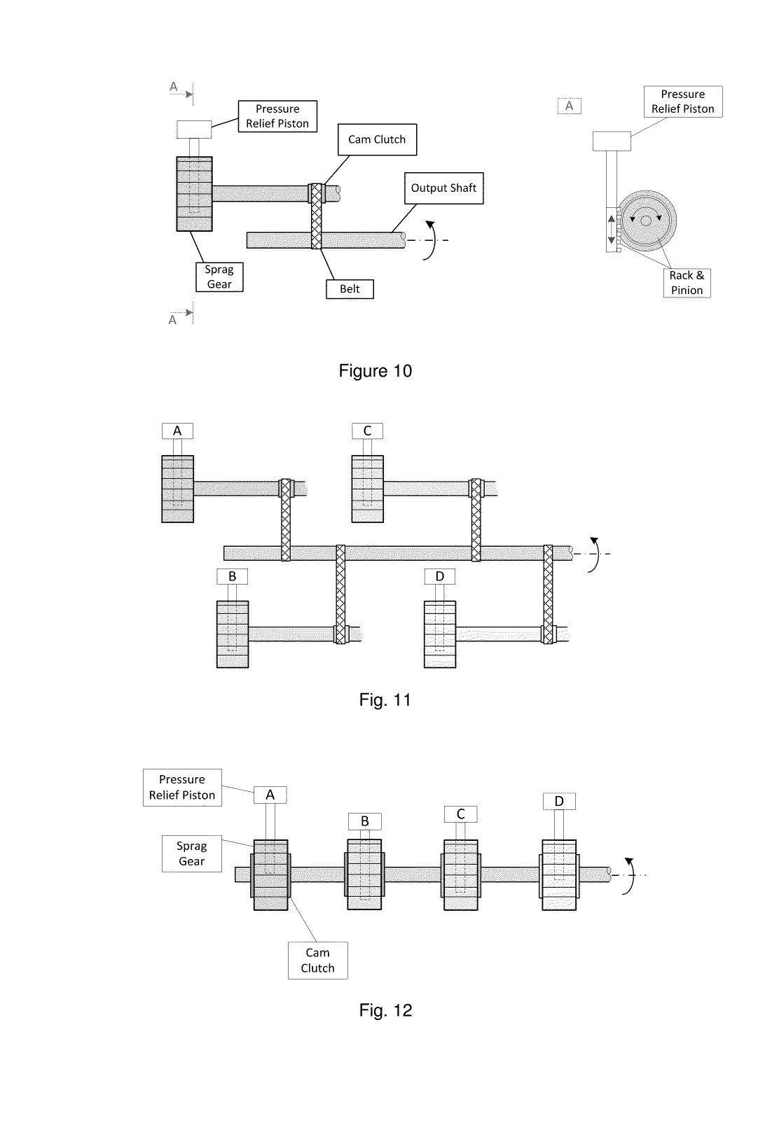

As can be seen from the FIG. 10, the transmission consists of a sprag gear, a cam clutch, a belt, and two shafts. The purpose of the sprag gear is to allow work to be transmitted to its mated shaft in one direction (when the pressure pulse occurs), and to freewheel in the other direction. This results in work being performed only when the core is heating, i.e. when the pressure pulse occurs. The cam clutch is implemented in order to allow transmission of work from the sprag gear shaft to the output shaft, but not the other way around. This allows multiple sources to provide power to the singular shaft without affecting each other.

FIG. 11 shows how an assembly consisting of four cores A, B, C, and D would appear. Additionally, FIG. 12 shows a more efficient and compact arrangement, which removes the need for belts or pulleys by concentrically mounting the sprag gear to the cam clutch and output shaft.

The stroke of each pressure relief piston can be altered by designing this piston face appropriately, as discussed previously in this document. For example, a larger stroke may be desirable for applications such as a valve train, where smooth continuous operation is required.

Due to the presence of the return spring, a proportion of the force created by the pressure pulse will be required to compress this spring. This force will be referred to as the return force. Therefore, in order to determine this force and hence the actual work produced by the pressure pulse, the desired spring must be defined.

Using Hooke's Law it is possible to define the required spring constant which would be used to define the spring which would allow the required overall deflection which it must undergo. Hooke's Law can be expressed via the following equation, where F is force, k is the spring constant, and x is displacement;

F=−kx

Since the primary function of the spring will be to displace a specific volume based on its piston face surface area, it is necessary to determine the correct value for the spring constant (k) and spring size which will perform as required. This can be achieved through the example which follows.

Begin by selecting an off the shelf spring, with appropriate dimensions. An example of such a spring is a LHC 250U 08M compression spring as supplied by leesprings.com. This spring has a relatively high spring constant (18.87 N/mm) as well as a relatively high stroke length (70.8 mm), when compared with other springs supplied. A high spring constant is required as the spring must be able to compress under the initial system pressure while allowing enough room for further compression under the pressure pulse. A sufficiently long stroke length is also important as the spring must be capable of deflecting by similar amounts as the main piston (30 mm) in addition to that caused by initial pressure. The appropriateness of this spring can be further examined as shown below.

The total available stroke for this spring, S_{T}, is 70.8 mm, however the allowable stroke will be less as over compressing a spring can damage its performance under cyclic loading. Some work has suggested that the allowable stroke be 85 percent of the total available stroke, in order to allow for cyclic loading, as referenced by Ellis, Norman. Considerations for sizing springs|News content from Machine Design. Machine Design. [Online] 16 Oct. 2012. [Cited: 9 May 2013.] http://machinedesign.com/news/considerations-sizing-springs. Therefore the actual available stroke, S_{A}, would be expressed as;

S_{A}=(0.85)S_{T}

S_{A}=(0.85)(70.8)=60.18 mm

The next step is to determine the initial displacement caused by system pressure, Pᵢ, of 2 Bar (200 kPa). For simplicity, the volumetric increase caused by the SMA wires will be neglected in this example. It will be assumed that the pressure relief piston will be designed to have the same piston head diameter as the main piston in order for it to displace the same amount of volume over the same stroke, so that the same sprag gears may be used for both pistons (as they will have the same stroke). The diameter of the main piston head is intended to be 60 mm in the gamma prototype of a sample drive. Taking these system parameters into consideration, the force exerted on the pressure relief piston, Fᵢ, can be determined as follows, where A is the piston face area of the pressure relief piston.

$${P}_{i =} \frac{{F}_{i}}{A}$$

$${F}_{i} = {P}_{i} A = ( 200 , 000 ) ( \frac{π {0.06}^{2}}{4} )$$

$${F}_{i} = 565.5 N$$

This force can now be input to Hooke's law in order to determine the initial deflection of the relaxation spring, xᵢ;

$${F}_{i} = - {kx}_{i}$$

$${x}_{i} = \frac{{F}_{i}}{k} = \frac{565.5}{18.87} = 29.97 mm$$

The stroke of the main piston, and hence the pressure relief piston in this example, during SMA contraction will be 30 mm. Therefore the total deflection, x_{f}, which the spring will undergo, will be;

x_{f}=xᵢ+x_{d}=29.97+30≅60 mm

∴x_{f}<S_{A}

Therefore, it can be said that this spring will be appropriate for this application, as it is capable of undergoing the required deflections within a cyclic range, as the operational stroke, x_{f}, is less than the available stroke, S_{A}.

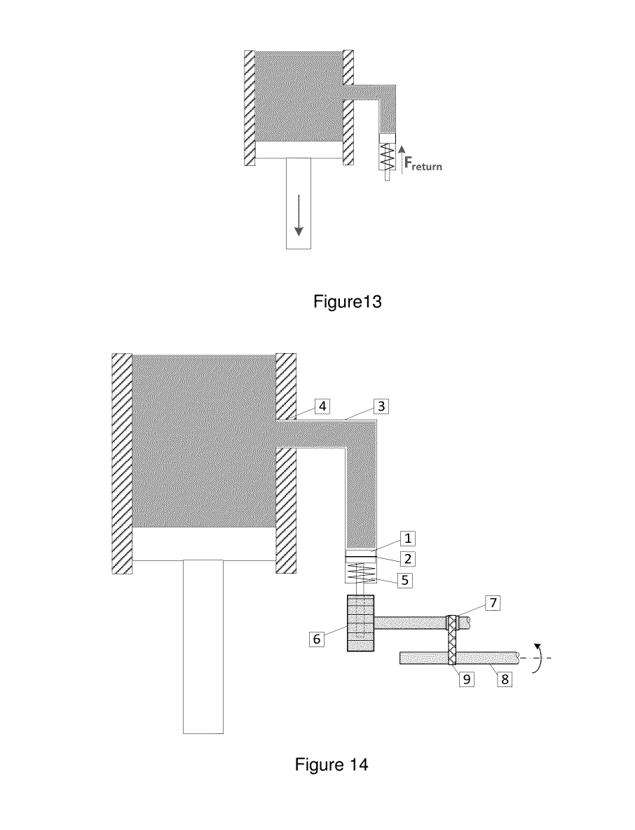

The final step is to determine the return force, Fᵣₑₜᵤᵣₙ, that will be required to return the piston back to its original position. This is achieved by once again using Hooke's law. The location of this force is also shown in FIG. 13.

$${F}_{return} = - {kx}_{d}$$

$${F}_{return} = ( 18.87 ) ( 30 ) [ \frac{N}{mm} \cdot mm ]$$

$${F}_{return} = 566.1 N$$

Therefore the total force which can be converted into usable work, F_{work}, can be represented as;

F_{work}=F_{f}−Fᵢ−Fᵣₑₜᵤᵣₙ

### Example Schematic

In another embodiment the construction of this pressure relief device may require but is not restricted to the following constituents, as illustrated in FIG. 14.

1. Pressure relief piston per core
2. Seals per pressure relief piston
3. Hydraulic line to connect core to piston per core
4. PH machining to allow connection point
5. Return spring per core
Transmission
   6. Sprag gear per core
   7. Cam clutch per core
   8. Output shaft
   9. FIG. 11 transmission—pulley belt per core or
FIG. 12 transmission—gear-to-clutch mount per core

### Self-Assisting Piston

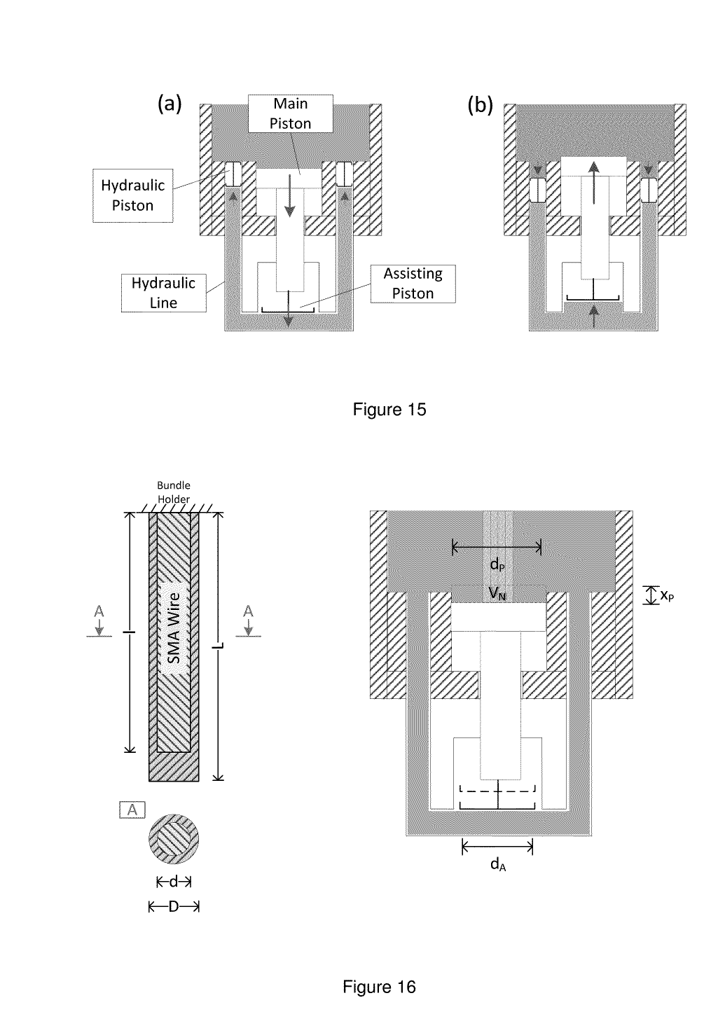

A self-assisting main piston is another embodiment of a PH design which eliminates the pressure pulse problem. This concept consists of a hydraulic line which travels from the main core to beneath the main piston, where there is a piston head of appropriate Cross Sectional Area (CSA) mechanically linked to said main piston. This arrangement will result in the volumetric decrease caused by the rising piston to be counter-acted by the equal volumetric increase that is now caused below it and vice versa. This operation is illustrated in FIG. 15 implementing a separate hydraulic line separated by pistons. It can be seen from this diagram that; (a) as the SMA cools, the main and assisting pistons descend, causing the hydraulic pistons to rise, (b) the SMA contracts as it is heated, which results in the main and assisting pistons rising, pushing the hydraulic pistons downward.

It can be seen from FIG. 15 that as the main piston descends during cooling, the piston below it lowers, permitting a volumetric exchange between the main core and the area below the main piston. The opposite occurs during the heating cycle, and hence, the core should experience no volumetric fluctuations. This will result in much greater freedom of movement for the main piston, while also removing the pressure pulsing issue.

### Design Considerations

A significant design consideration for this concept is the assisting piston. The face surface area of this component must be of a value such that it will displace a volume equal to that of the main piston head. This is due to the fact that the main piston and the assisting piston heads are fixed to one another. Therefore they have the same available stroke. Hence, whatever displacement one side undergoes so must the other. Specifying the correct face surface area of the assisting piston by means of its diameter may be achieved by considering various factors. This will be performed by determining the volume displaced by the main piston head after considering the effect of the SMA contraction. The SMA wires will contract both axially and radially which will result in an increase in the system volume. This volumetric change will counteract the volumetric decrease caused by a rising main piston. A procedure for determining the correct assisting piston size is outlined below.

The contraction undergone by the SMA wire is caused by Bain strain. This results in the wire contracting in all directions. In the case of a wire the contractions occur linearly and radially. This is shown in FIG. 16, where the wire length reduces from L to I, and the diameter reduces from D to d. The basic geometries of the piston housing mechanisms are also shown in this figure, where a direct hydraulic line is implemented in place of double headed pistons.

In order to determine the correct diameter of the piston shaft, the following procedure should be followed:
1. Determine the volumetric change caused by the linear contraction of the SMA.
   a. Define the initial CSA, A₁, of each individual wire;

$${A}_{1} = \frac{π {D}^{2}}{4}$$

Where D=Diameter of wire before contraction.
   b. Calculate the volume displaced by linear contraction, V₁;

V₁=A₁(L−l)
Where L=Length of SMA wire before contraction, and l=Length of SMA wire after contraction.
2. Determine the volume displaced by radial contraction.
   a. Find the CSA of the radial contraction, A₂, which is seen to be the difference in the CSA's of the wire before and after contraction;

$${A}_{2} = \frac{π {D}^{2}}{4} - \frac{π {d}^{2}}{4} = \frac{π {D}^{2} - π {d}^{2}}{4}$$

Where d=diameter after contraction.
   b. Calculate the volume displaced by radial contract, V₂;

V₂=A₂l
3. Determine the total volumetric reduction of the SMA wires, V_{T}.

V_{T}=(V₁+V₂)N
Where N=Number of SMA wires in bundle
4. Calculate the volume displaced by main piston.
   a. Determine volume displaced over a stroke, x_{P};

$${V}_{M} = {A}_{p} {x}_{p} = \frac{π {d}_{p}^{2}}{4} {x}_{P}$$

Where Aₚ=face surface area of the main piston, and d_{P}=diameter of the main piston head.
   b. Determine actual volume, V_{N}, displaced by main piston, accounting for volumetric offset caused by SMA contraction;

V_{N}=V_{M}−V_{T}
5. Define appropriate assisting piston head diameter based on required volume to be displaced per stroke, V_{A}.

$${V}_{A} = {V}_{N} = {A}_{A} {x}_{P}$$

$${A}_{A} = \frac{{V}_{N}}{{x}_{P}}$$

$$\frac{π {d}_{A}^{2}}{4} = \frac{{V}_{N}}{{x}_{P}}$$

$${d}_{A} = 2 \sqrt{\frac{{V}_{N}}{{x}_{P} π}}$$

Where A_{A}=Face area of assisting piston, and d_{A}=Diameter of assisting piston head.

### Hydraulic Piston Concept Design Considerations

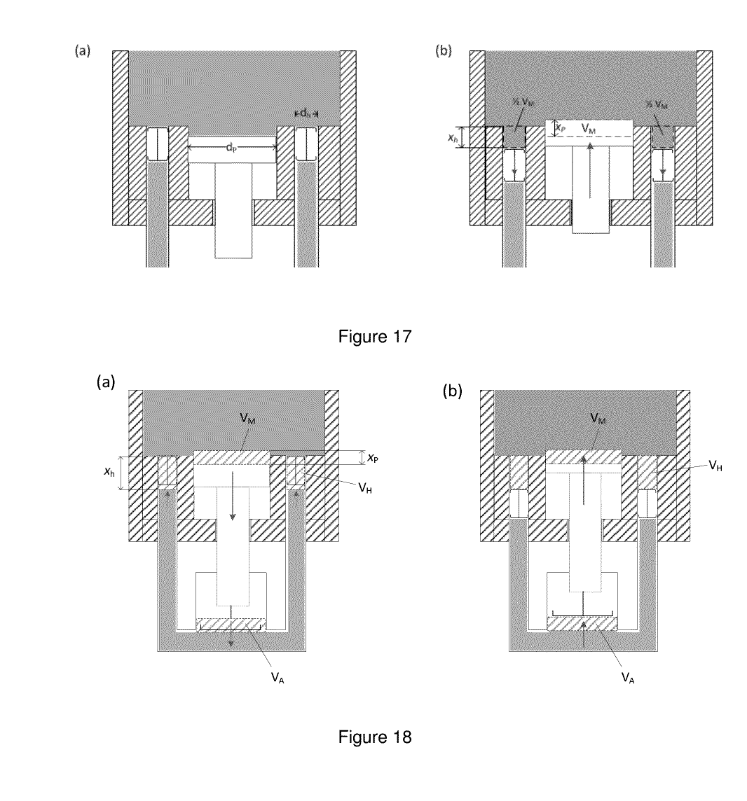

Factors which should be considered for designing the pressure relief piston heads in the concept shown in FIG. 15 are the CSA of the hydraulic piston heads, and the required level of deflection. Both of these factors will be functions of the deflection and displaced volume of the main SMA actuated main piston head. Consider the system shown in FIG. 17.

Firstly, one must determine the value for volume displaced by the main piston head (V_{M}). This is achieved simply, by using the equation for the volume of a cylinder;

V_{M}=Aₚxₚ

Where Aₚ is the area of the main piston face, and xₚ is its deflection.

Once again, using the equation for volume of a cylinder, the dimensions of the pressure relief piston head can be calculated, provided either the allowable deflection (xₕ) or piston face diameter (dₕ) of the component is known or desired. This methodology can be applied to designing a piston head for use with the hydraulic line of a motorbike master cylinder, for example. In such a device there is an allowable movement of roughly 10 mm. Assuming the required volume to be displaced is already calculated, the following procedure can be followed to determine an appropriate hydraulic piston face diameter, where Aₕ is the area of the hydraulic piston face. Due to the presence of two hydraulic pressure relief pistons, the volume which they must displace each will be half of that displaced by the main piston.

$$\frac{{V}_{M}}{2} = {A}_{h} {x}_{h}$$

$${A}_{h} = \frac{{V}_{M}}{2 {x}_{h}}$$

$$\frac{π {d}_{h}^{2}}{4} = \frac{{V}_{M}}{2 {x}_{h}}$$

$${d}_{h} = \sqrt{\frac{2 {V}_{M}}{π {x}_{h}}}$$

The above equation would be most appropriate for use when the deflection of the piston, xₕ, is known, due possibly to the allowable movement which the hydraulic piston can move (perhaps due to the geometries of the system). A method of determining the value of its diameter is discussed below, and would be appropriate where the piston head diameter is fixed (as it may be based on available standard piston parts). It may also be possible to derive an ideal value for these variables by designing the components so that the effects of friction are reduced.

It can be seen in FIG. 18 that the movement of the main piston (x_{M}) and hydraulic pistons (xₕ) may differ, but the overall volumetric displacement will always remain constant (V_{M} and 2V_{H}). This relationship can be used to derive an expression which will relate x_{M} and xₕ, in a situation where the hydraulic piston head diameter is known.

It can be seen from FIG. 18 that the deflection of the main piston, x_{P}, and the deflection of the hydraulic pistons, x_{H}, are related as follows, where the d_{P} is the diameter of the main piston, and considerations for the SMA wire's effect on the volume of the core have been given;

$${V}_{M} = {V}_{A} = 2 {V}_{H} \\ ∴ \frac{ {d}_{P}^{2}}{4} {x}_{P} = \frac{2 {d}_{h}^{2}}{4} {x}_{h}$$

$${x}_{h} = \frac{{d}_{P}^{2}}{2 {d}_{h}^{2}} \cdot {x}_{P}$$

This relationship can be derived from the fact that any movements incurred by the hydraulic pistons will be a result of the main pistons movement as well as the fact that the volumetric changes must cancel each other out. The equation relating the volumes above can be found by considering the fact that any volumetric displacement caused by the main piston head (V_{M}), an equal volumetric displacement must be experienced on the assisting piston head (V_{A}). Due to the presence of two hydraulic pistons, the volumetric displacement caused by the main piston head is split evenly over these two pistons. The total volume moved by these pistons (2V_{H}) is equal to that displaced by the main piston, and hence will allow for volumes to be exchanged above and below the main piston. As discussed previously, this should allow for the piston to “assist” its own movement, allowing for a greater degree of freedom of movement.

### Example Schematic

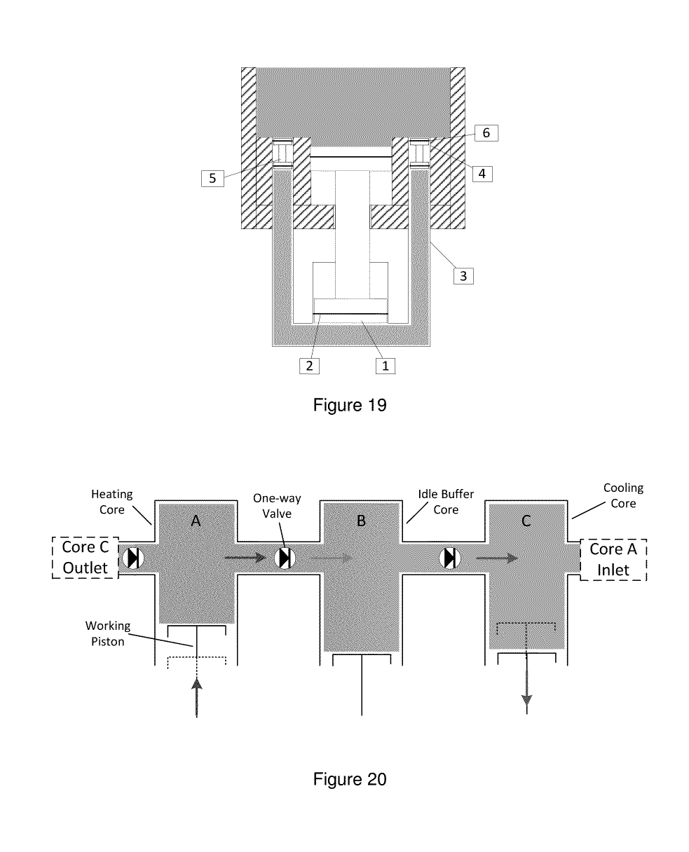

The construction of this pressure relief device may require but is not restricted to the following constituents, as seen in FIG. 19;

### Concept A

1. Assisting piston per core
2. Assisting piston seal per core
3. Fluid line for connecting core to assisting piston per core
4. PH machining
5. Appropriate no. of hydraulic double headed pistons per core (if required)
6. Two seals per hydraulic piston

### Regenerator Fluid Exchange Embodiment

As discussed previously, the pulsing issue arises from a volumetric change caused by the movement of the working piston in the system cores. During the operation of these cores a working fluid is passed over SMA bundles. This fluid is sequentially altered between hot and cold flows, and induces a phase change in the SMA components. When heated, the SMA component contracts, lifting the connected piston and thereby causing a reduction of volume in the system, as shown in FIG. 1. It can be that as the piston rises, the distance from the head of the piston to the core outlet is reduced from z₁ to z₂, which in turn reduces the volume.

An issue which can arise from this concept is the movement of hot fluid to a cold fluid flow or vice versa. This gives rise to the requirement of a buffer core between heating and cooling cores which itself will not be actively heating or cooling. This core will accept heated fluid from an actively heating core, and pass on cold fluid to an actively cooling core. The necessity of this idle or buffer core represents additional size, costs, and losses to the system, and hence may not be desirable. Therefore a method of performing the task of this core, in a more compact format is advantageous. An embodiment of the fluid exchange concept implementing a buffer core is shown in FIG. 20.

The implementation of a regenerative heat exchanger or regenerator could offer a more viable method of altering the temperature of the fluid flow. Regenerators are used to store extracted heat from hot fluid flows. The invention makes use of the fact that the idle core can be replaced by the regenerator.

### Operation of Regenerator

Regenerative heat exchangers are common industrial components. They are also a critical component in Stirling cycle heat engines, whereby they permit increases in overall energy efficiency of the engine through the recycling of stored heat between cycled heating and cooling phases.

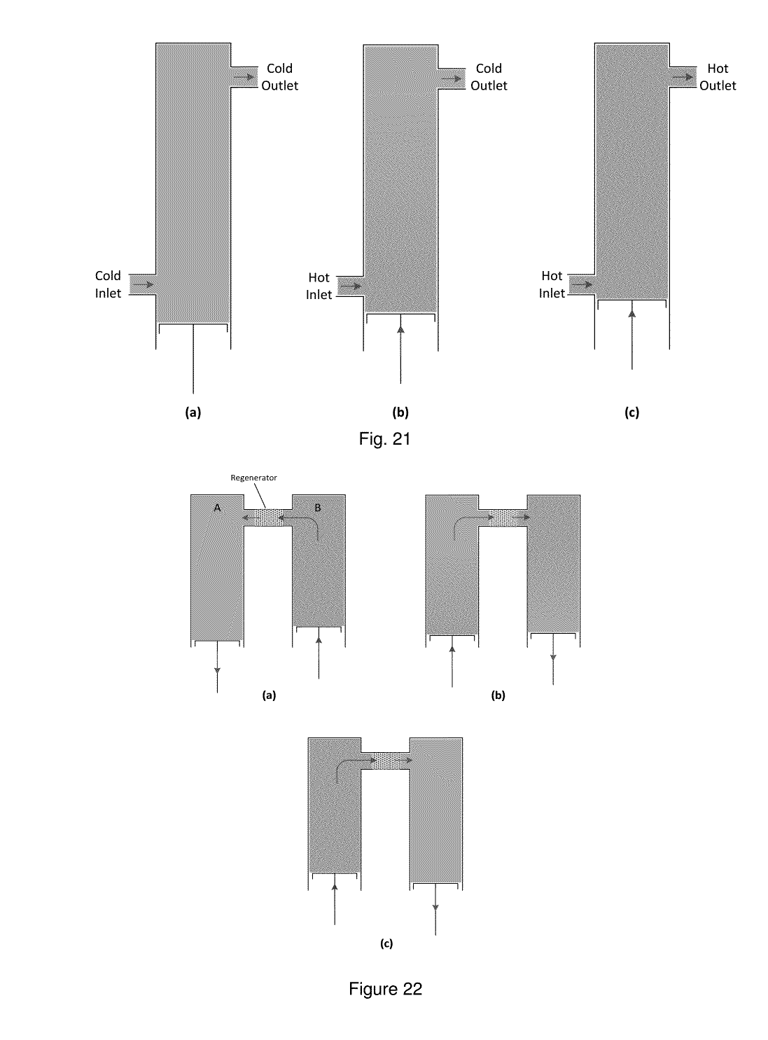

The present invention describes an embodiment which a regenerative heat exchanger can be deployed to help optimise heat performance. The primary considerations for the regenerator's application is the sequence of fluid delivery to the system. This involves switching between hot and cold flows through the cores. Due to fluid delivery control constraints, the two cores must operate in opposing sequences in order to maintain a constant flow rate. There is also consideration given for flushing out cores when switching from hot to cold in order to prevent hot fluid returning to the cold tank and vice versa. This results in a delay between the opening of a hot inlet to a core and closing of a cold outlet for the same core (and hence opening of a hot outlet). This results in a transition from hot to cold flows from the outlet during the cooling cycle of the cores, while the opposite is true of the heating cycle. This is illustrated in FIG. 21.

FIG. 21 shows heating flow cycle of an individual core where; (a) the core is fully cooled and about to start heating, (b) the core begins heating as cold inlet is closed, and the hot inlet opened, while cold fluid is still flowing (flushed) through the cold outlet, and (c) the core fills with hot fluid and the hot outlet is opened, while the working piston continues to rise. The opposite operation (with respect to the hot and cold flows) is true of the cooling cycle.

Considering the cycle displayed in FIG. 21, were the regenerator placed at the outlet, it would undergo the same flow conditions of cold to hot during the cooling cycle, and cold to hot during the heating cycle. FIG. 22 illustrates the operation of a regenerator in this application when linked between two cores of opposite heating/cooling cycles.

FIG. 22 illustrates the operation of the regenerator where; (a) core B passes heated water to core A towards the end of its cycle giving up heat to the regenerator as it joins the cold flow of core A, (b) core A begins heating forcing cold fluid through the regenerator which heats this flow as it meets the heated fluid being flushed from core B, and (c) the regenerator has deposited all its heat as both cores finish flushing, and a heated flow now passes through the regenerator, as it occurred previously in opposite cores in (a).

The operation shown above indicates that the regenerator provides an effective solution. The regenerator would have to be designed specifically for this application, however. The regenerator must be capable of retaining enough heat from the hot flow in the given amount of time (tₕ) in order to sufficiently cool it, while also being able to dispense said heat to cold water in the given amount of time (t_{c}) in order to adequately heat it. These time periods can be represented as follows;

t_{c}=t_{flush}

tₕ=t_{cycle}−t_{flush}

Where t_{flush} is the time taken for flushing out hot/cold water during switch over, and t_{cycle} is the time taken per individual heating/cooling cycle.

There are various factors which may have an impact on the performance of the regenerator and its ability to absorb and dissipate heat. Such factors may include the material from which it is manufactured or its length. FIG. 23 shows a predicted temperature-time performance for this regenerator in the process discussed in FIG. 22 above for one second heating/cooling cycle times.

FIG. 23 illustrates the Temperature vs time curve for the regenerator in the Drive application according to one embodiment.

It should be noted, however, that unlike other heat engines such as the Stirling cycle engine, the regenerator used in the present invention does not experience the full mass flow rate of the heating and cooling fluids in operation (the heated and cooled water streams for example). Rather, only a portion of the total mass flow rate, corresponding to the mass displaced during pressure pulses in the cycle, is transferred through the regenerator. The balance exits the system immediately via the appropriate valve systems.

### Volume Exchange Pressure Relief Embodiment

As discussed previously with respect to FIG. 1, the pulsing issue arises from a volumetric change caused by the movement of the working piston in the system cores. During the operation of these cores a working fluid is passed over SMA bundles. This fluid is sequentially altered between hot and cold flows, and induces a phase change in the SMA components. When heated, the SMA component contracts, lifting the connected piston and thereby causing a reduction of volume in the system. The pressure pulse issue may be solved through the use of an adjoining piston or hydraulic line between cores. This connection would “exchange” the displaced volume between these cores, thereby eliminating the pressure pulse. This concept may be applied to various embodiments of the invention.

### Pressure Relief Operation

The volume exchange would be achieved through a connection between each core, where a two headed piston or hydraulic line will be present. This will lead to pressure being relieved, as excess volume from a heating core can be passed on to a cooling core, compensating for its increase in volume. The connection would be attached at the core outlets. FIG. 24 illustrates the two possible configurations.

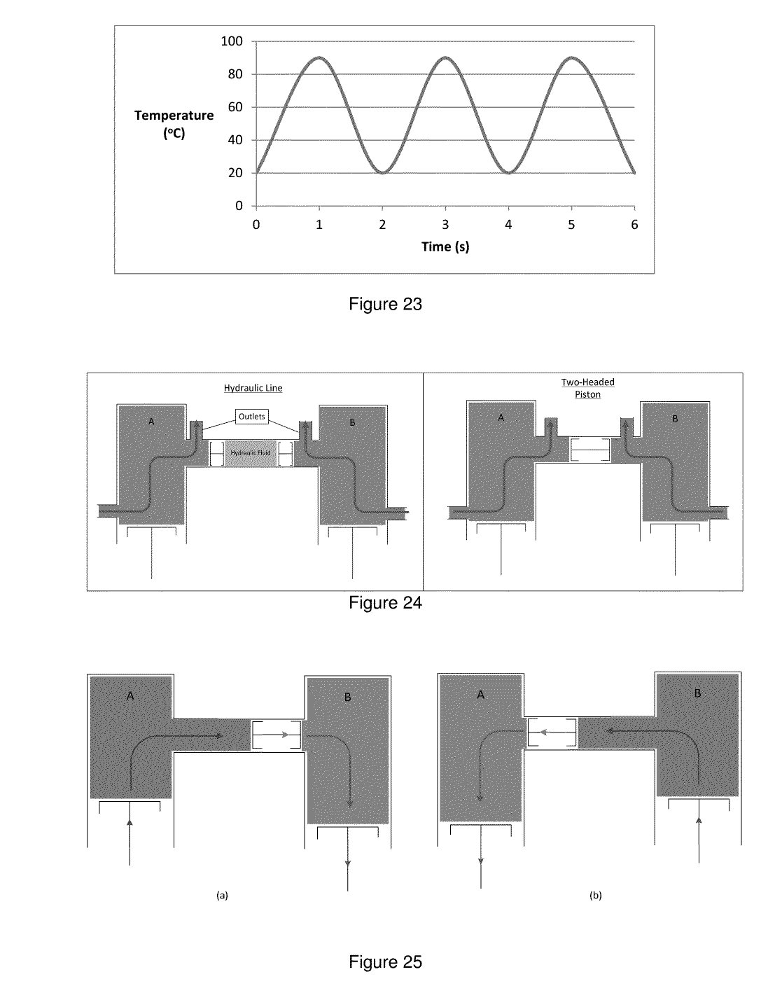

In its simplest incarnation, where there are two cores operating in an opposing sequence with respect to the hot and cold flows through them. This embodiment is illustrated in FIG. 25. It can be seen that as core A heats, it causes the working piston head to rise, the volume contained within said core is reduced, while the opposite is true for core B, which is cooling. The connecting pressure relief component remedies this by shifting the volume displaced from the heating core to assist in the descent of the working piston in the cooling core. This mechanism results in both cores experiencing a constant volume, and hence, no pressure variance. This sequence is then repeated as core B begins to heat, and core A cools.

The operation discussed above will apply to any system which implements any multiple of blocks of two cores with opposing and equal heating and cooling cycles. However, this may not always be the case. There may be circumstances where the heating and cooling times are disparate. In this situation, there will be three or more cores operating simultaneously, where different cores are heating and cooling at different stages. The pressure pulses created during the operation of such a system would be counter-acted by connecting all cores in the system with a pressure relief line, i.e. all core outlets would be connected by this line.

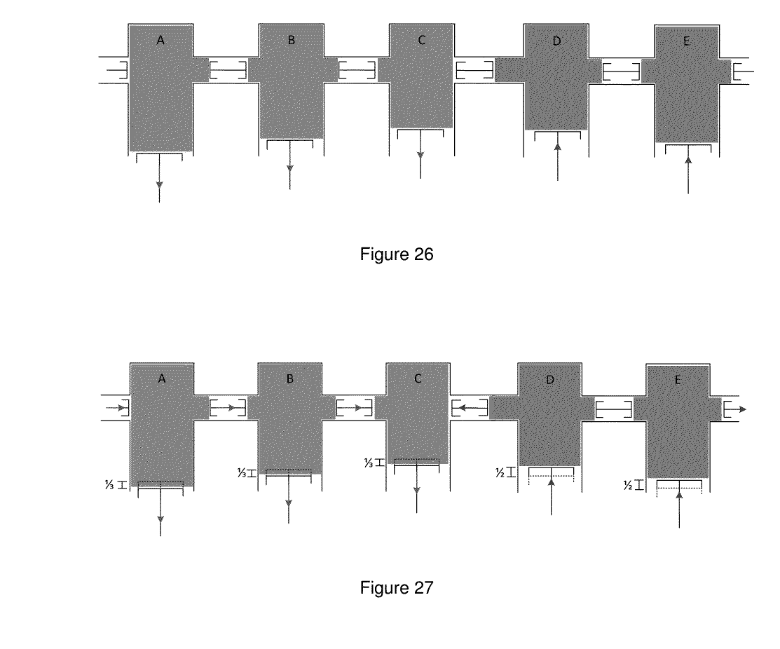

Consider the system shown in FIG. 26. This system has a ratio of heating time to cooling time of 2:3, and as a result of this and due to fluid delivery control constraints, may require at least five cores to operate correctly. There may also be idle cores present, which are intended to improve the fatigue life of the working SMA. Due to the constraints applied to this configuration, at any given time there will be two cores heating, and three cores cooling. In terms of volume this means there will be two cores reducing their volume, and three increasing theirs. The addition of the pressure relief components discussed previously would remedy any pressure variance related issues. The pressure relief would essentially “link” the volumes of all the cores. This would result in a change in any one of the core's volumes, will have an effect on all other cores in the system.

In order for the system to completely eliminate the pressure pulse, the volumetric increases in the system must be equal to the volumetric decreases. This is what occurs in this particular configuration, due to the rate at which the cores heat and cool. As FIG. 27 shows, as the two heating cores rise over half the time taken to fully heat a core, they displace ½ of the volume displaced by a full contraction of the SMA. The three cooling cores displace ⅓ of this volume by reduction. It can be deduced from this that in this time, the combined decrease in volume in the system is equal to that caused by one full rising of the piston, while the combined increase is equal to that caused by one full lowering of the piston. Hence, the total volumetric change across the system will be zero, as the increases and decreases will cancel each other out.

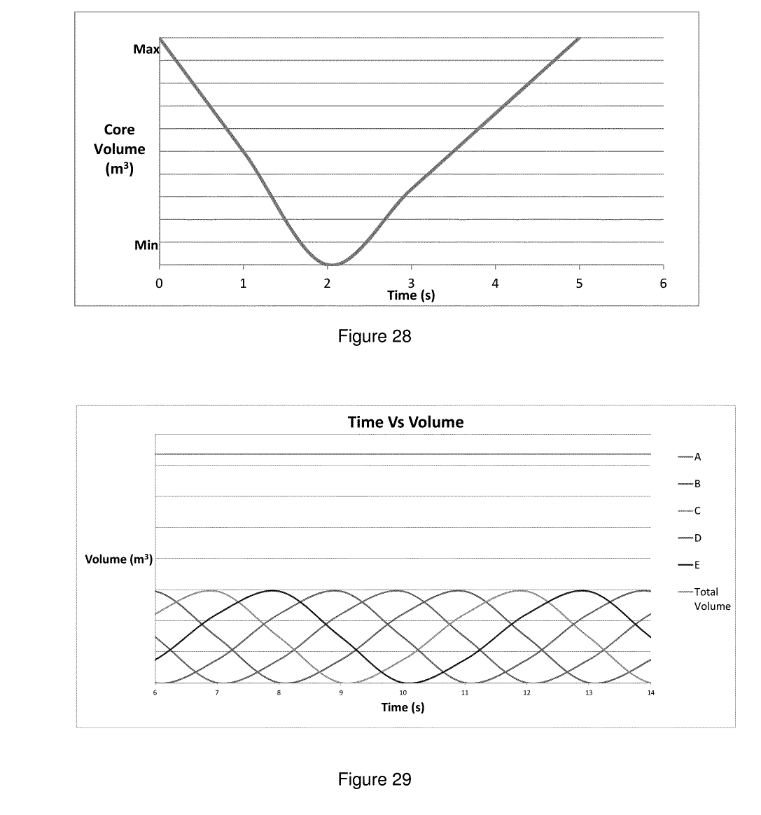

In the example discussed above, the reduction in volume caused by the rising piston head is performed at a faster rate than the increase caused when the piston descends. This is shown in the graph in FIG. 28, where the data points are arbitrarily chosen to represent a percentage of the total volumetric reduction which occurs within a single core over a time period of five seconds.

For the five core system discussed previously, these cores can be combined, where each cycle is offset by the appropriate amount. This delay between cycles will be defined by the number of cores, as well as the heating to cooling times ratio. The graph in FIG. 29 illustrates the five core system volume variation for each core (denoted as letters A through E), as well as the total fluid volume of the system, which can be seen to be constant. It will be understood from this that in the case of the multiple core system described, the volume reduction in the contracting cores is offset by volume increases in neighbouring expanding cores, such that the net system volume remains constant at all times.

### Piston Pressure Relief Mechanical Operation—Series

Below is a nomenclature for this section, which is intended to assist in understanding the concepts discussed herein.

| | |
|---|---|
| S_{P} | Stroke of hydraulic piston |
| S_{C} | Stroke of main piston |
| a | Linear displacement of main piston caused by SMA contraction |
| b | One third the displacement of main piston caused by SMA |
| | contraction |
| c | One sixth the displacement of main piston caused by SMA |
| | contraction |
| d | One half the displacement of main piston caused by SMA contraction |

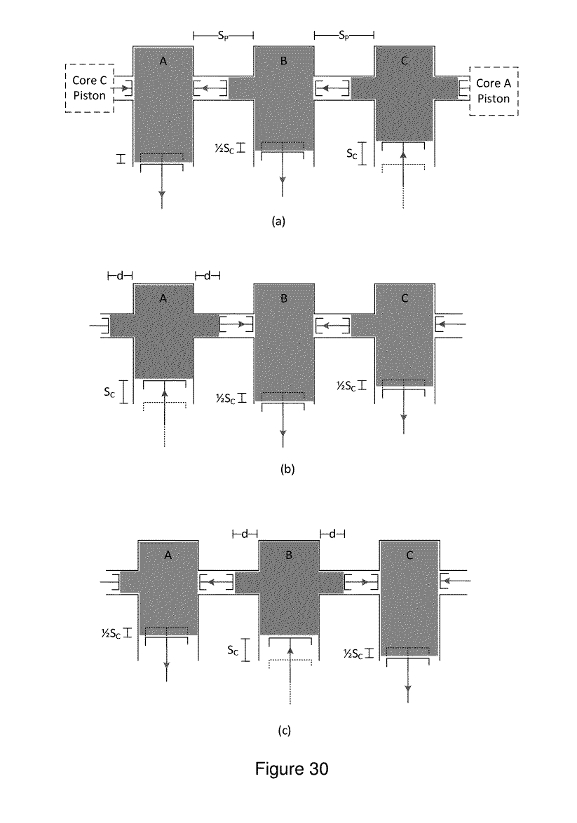

In order to properly design a mechanism which will perform the operations discussed above it is important to accurately predict the behaviour of the device in situ. A model will be used to examine the mechanical actions that occur during system operation, and ensure the device will function correctly. Consider an embodiment which entails a heating to cooling ratio of 1:2. As a result of this ratio and due to fluid delivery control constraints, the system will require at least three cores, whereby at any given time, the arrangement will consist of one heating core, and two cooling cores. FIG. 30 illustrates how the pressure relief mechanism would operate within this system. The steps shown in this diagram are in time intervals equal to that required to fully heat a core.

It can be seen from FIG. 30 that as one core heats, its connected pistons are forced to move, maintaining a constant volume present in it and the cooling cores in the system. In the time it takes the piston in a heating core to complete a stroke (S_{C}), the cooling core's pistons complete half this stroke. This means that the volume displaced in the heating core will be split in half and evenly distributed to these cooling cores, as can be seen when the connecting pistons displace half this stroke (d) and volume each. As can be seen from (a), piston C rises and completes a stroke and this causes the connecting pistons (from C to B, and C to A) to move, each displacing a volume equal to half that displaced by the main piston head. These displacements then assist in lowering the pistons in cores A and B.

While the model discussed above successfully describes the operation of the pressure relief device, it may not succeed in describing all cases which may occur. In this embodiment, the order in which the cores were arranged, with respect to heating and cooling cores, did not affect the operation of the pressure relief mechanism. This may not always be the case.

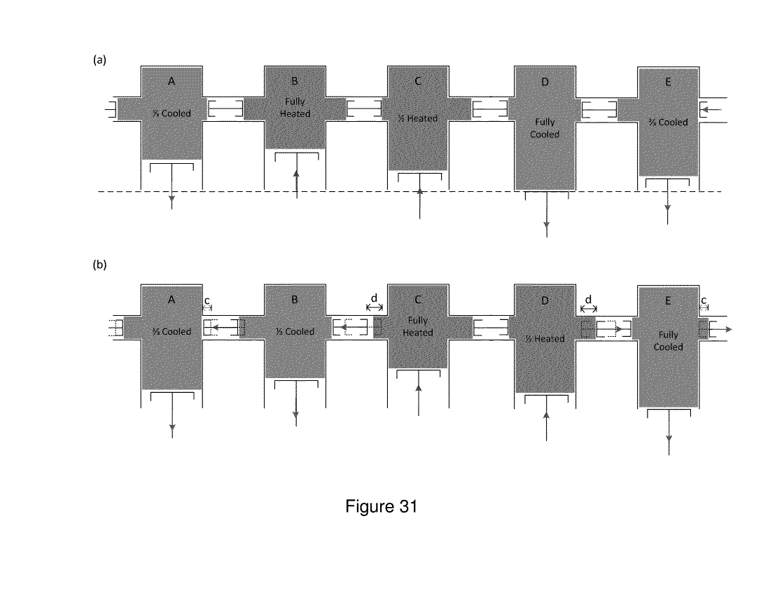

Consider a system similar to that described in FIG. 27. The operation of the mechanism is similar to that discussed above, except that the order in which the cores are organised may have an impact on the operation of the piston pressure relief device. For the given system, it can be seen that the two heating cores are located side by side. FIG. 31 illustrates this system and the state of each core in the sequence.

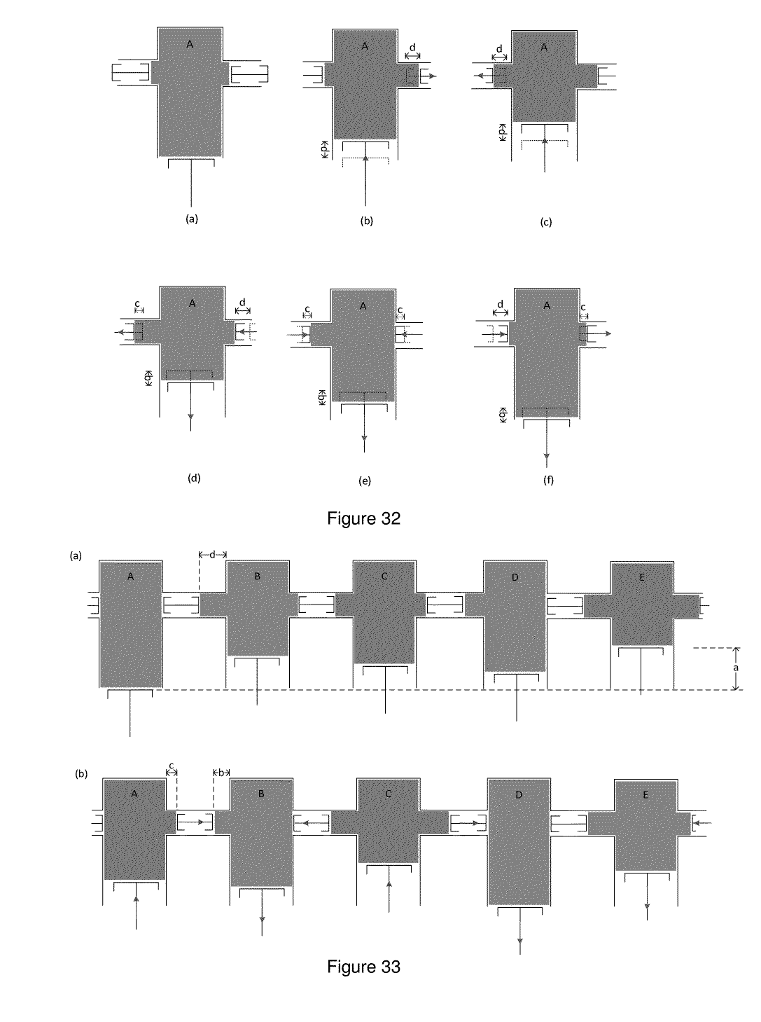

It can be seen from the FIG. 31 that the volume changes are exchanged between cores by increments of either ½ (d) or ⅙ (c) the total volume displaced per stroke. This results in the overall volume required to be displaced by this arrangement is equal to that displaced by each main piston stroke. The cycle through which each core undergoes is illustrated in FIG. 32. It can be seen that the total stroke per pressure relief piston over the course of the cycle is ⅔ the stroke of the main piston;

$${S}_{P} = d + c = \frac{2}{3} {S}_{C}$$

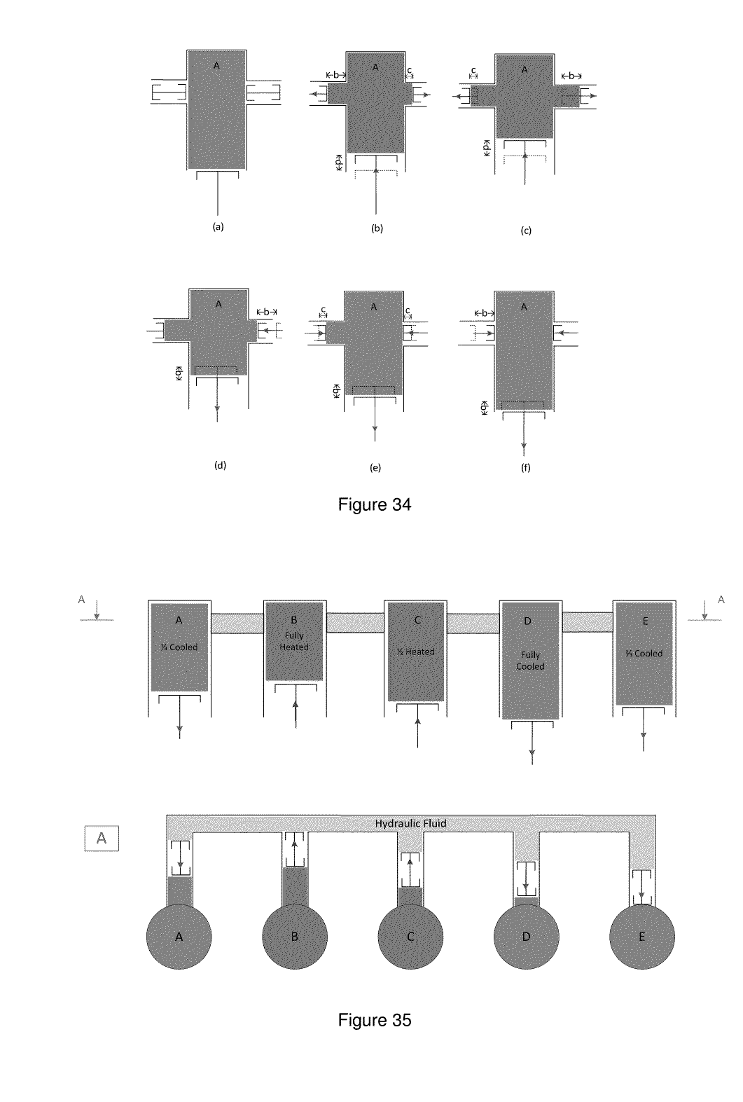

Another arrangement which may exist is shown in FIG. 33. In this embodiment, the heating cores are not located immediately next to each other, but are separated by a cooling core. It can be seen from this diagram and FIG. 34 that the order in which the cores are arranged affects the geometry of the system. When compared with the previous example, this incarnation of the system requires that the pressure relief piston have a shorter stroke (by ⅙ the volume displaced by contraction).

It can be seen from FIG. 34 discussed above that the volume changes are exchanged between cores by increments of either ⅓ (b) or ⅙ the total volume displaced per stroke. This results in the overall volume required to be displaced by this arrangement is equal to half that displaced by each stroke of the main piston, as shown below.

$${S}_{P} = b + c = \frac{1}{2} {S}_{C}$$

The cycle through which each core undergoes is illustrated in FIG. 34.

Therefore, it can be said that one must consider the order in which the cores are placed when designing the pressure relief device, as this will affect its dimensions i.e. the pressure pistons stroke was shorter for the second example discussed. This may be problematic for some applications as there may be a requirement to alter the order in which cores heat and cool. Furthermore, the implementation of idle cores into the system may serve to compound this issue even further. In this case it may be more desirable to use parallel arrangement.

### Piston Pressure Relief Mechanical Operation—Parallel

A more advantageous arrangement for the pressure relief mechanism may be a parallel one. In a parallel arrangement, the order of heating, cooling, and idle cores would be irrelevant to the devices operation. The volume fluctuations will be fed from one core to any number that will or need to take, irrespective of whether they are in any specific order. This would alleviate the issues arising from the implementation of idle cores where the pressure pistons are arranged in series, as discussed above.

As can be seen from FIG. 35, as any number of cores heat and produce volume variation, these displacements are counteracted by the cooling cores, regardless of whether there are idle cores present, nor the order in which they are placed. The method of parallel arrangement offers greater advantages over a series embodiment, as the system will self-allocate the volumetric displacements and will allow for these to travel to relevant cores without disrupting those which remain idle.

### Friction Analysis

An issue which may arise during the operation of this method of pressure regulation is that associated with the presence of friction, particularly when the mechanism is arranged in series. This is caused by (in relation to the device itself, not the whole system) the kinetic friction present between the piston and its housing, or more specifically between the piston seal and its housing wall. This frictional force will oppose the movement of the piston in whichever direction it attempts to traverse. However, the pressures and fluctuations which will be present in a sample Drive will be relatively large (>2 Bar) compared with the piston face area (≅60 mm), and hence should overcome these frictional forces.

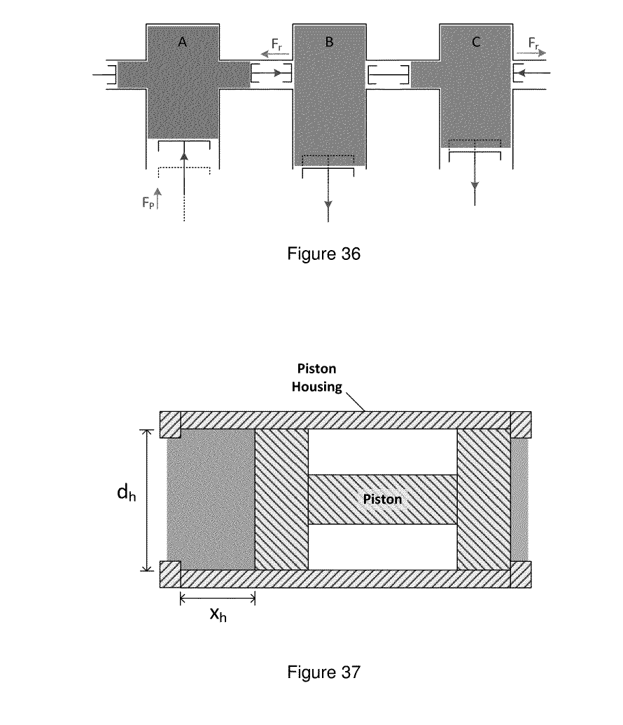

An aspect of the pressure relief concept discussed herein which may increase the extent of friction is the compounding effect which occurs when it is arranged in series. Due to the properties of this arrangement, the opposing force caused by the friction will be a multiple of the number of pistons in this line. This results in the pressure required to overcome this force will increase as it travels from core to core. While individually the frictional forces may not be significant when compared to the forces created by the pressure fluctuations, when in series as discussed, they may compound and begin to impede the movement of the pistons and hence the transfer of volume between cores. This would result in the device malfunctioning, and hence should be considered in the devices design. FIG. 36 illustrates the presence of these opposing frictional forces.

As can be seen in FIG. 36, the rising piston head will produce a pressure pulsing force, Fₚ, and the pressure pistons will produce opposing frictional forces, Fᵣ, which will resist movement. Using this illustration, the following can be stated.

The main piston head will overcome the frictional forces if;

F_{P}>nFᵣ

Where n is the number of hydraulic pistons.

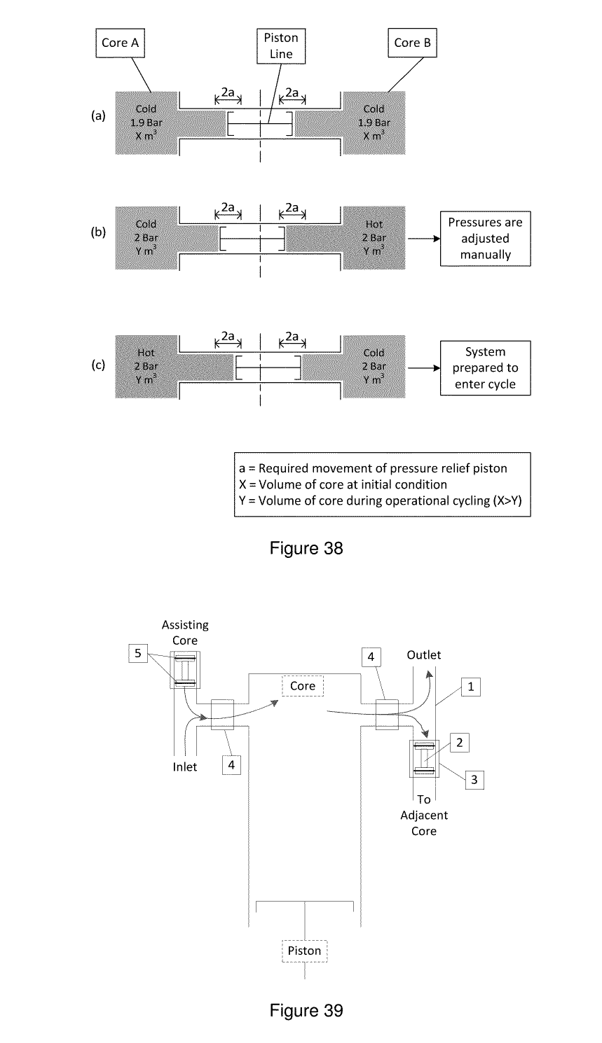

Therefore, in the example given in FIG. 38, Fₚ must be greater than 2Fᵣ in order to successfully transmit volume between cores.

### Piston Face Design

Below is a nomenclature for this section, which is intended to assist in understanding the concepts discussed herein.

| | |
|---|---|
| V | Volume displaced by main piston head after considerations have been |
| | given for volumetric variations caused by the SMA |
| A_{P} | Face surface area of main piston head |
| Aₕ | Face surface area of hydraulic piston head |
| x_{P} | Linear displacement of main piston head caused by SMA contraction |
| xₕ | Linear displacement of hydraulic piston |
| dₕ | Diameter of hydraulic piston head |

The main factors which must be considered for designing the pressure relief piston head are the Cross Sectional Area (CSA) of the head, and the required level of deflection. Both of these factors will be functions of the deflection and displaced volume of the main SMA actuated piston head. FIG. 37 illustrates these dimensions.

Firstly, one must determine the value for volume displaced by the main piston head. This is achieved simply, by using the equation for the volume of a cylinder;

V=Aₚxₚ

Once again, using the equation for volume of a cylinder, the dimensions of the pressure relief piston head can be calculated, provided either the allowable deflection or piston face diameter of the component is known. This methodology can be applied to designing a piston head for use with the hydraulic line of a motorbike master cylinder, for example. In such a device there is an allowable movement of roughly 10 mm. Assuming the required volume to be displaced is already calculated, the following procedure can be followed to determine an appropriate piston face diameter.

$$V = {A}_{h} {x}_{h}$$

$${A}_{h} = \frac{V}{{x}_{h}}$$

$$\frac{π {d}_{h}^{2}}{4} = \frac{V}{{x}_{h}}$$

$${d}_{h} = \sqrt{\frac{4 V}{π {x}_{h}}}$$

The above procedure may be manipulated to determine the required allowable deflection for a specified face diameter. An example of when this may be appropriate could be designing the device for use with standard piston parts.

### Start-Up Operation

It may be appreciated that there exists a situation in which the pressure relief piston described previously might not be optimally positioned within its chamber. This may happen during initial filling of the system, whereby incorrect or otherwise imprecise filling of the cores in sequence may permit Core A to fill fully and also to fill all or a portion of the pressure relief piston chamber. This would cause the pressure relief piston to bias towards the second core, Core B.

Upon start-up of the system, the pressure relief piston would therefore begin oscillating from a non-central position. This could give rise to a scenario in which the pressure peaks in each core are disparate, as the volumes exchanged are different due to the biased starting conditions.

It is possible to create the required condition for the system/pressure relief components to cycle by either manually altering the pressure within the cores or by restraining the pressure relief piston at the priming phase of the cycle. A process used to perform this is shown in FIG. 38.

It can be seen from the figure above that at the initial stage, (a), both sides of the piston (i.e. both cores) are cooled and hence, the pistons within these cores will be at their lowest position. It should be noted that in this example there are only two cores present, which are intended to be operated at 2 Bar. It can be seen from the diagram that the pistons are given a freedom of movement of at least twice their required deflection (i.e. the distance which they must be capable of travelling in order to transmit the volume displaced by the working piston.

In FIG. 38 at the stage shown at (a), the pressure relief piston will be located at the centre of its freedom of movement. This is due to the presence of equal pressure being applied at both sides of the piston. In this stage, the system pressure in both cores should be less than the intended operational pressure. In stage (b), one of the cores is heated and the SMA is allowed to fully contract. This will result in volumetric decrease in both cores as the now rising piston head in core B will push the pressure relief piston head in the direction of the cooling core A, until the pressure on either side of the piston is equal. This movement of the pressure relief piston will reduce the volume within the cooling core as its working piston will not have freedom to move, while the heating core will also experience a volumetric decrease as not all the volume displaced by the rising working piston will be passed on to the cooling core. At this point the pressure relief piston will be offset from its original centred position, hence the reason for giving the piston twice its required degree of freedom. As the system reaches a static position (core A fully cooled, and core B fully heated) and equal pressures are present on both sides of the piston, these pressures can be manually increased simultaneously to the operational pressure of 2 Bar. Finally, stage (c) shows how the system can enter its operational cycle, where core A is heated and core B is cooled. During these heating and cooling operations, the pressure relief will move appropriately from left to right in order to pass the volumetric displacements caused by the heating core into the cooling cores, while maintaining a constant system pressure of 2 Bar.

It should be noted that the example discussed above uses a two core system, but it may be possible to expand this methodology in order to apply it to a system with a greater number of cores.

### Mechanical Linkage Concept

An embodiment which the volume exchange concept may take is through the use of mechanical linkage, as opposed to hydraulic as discussed previously.

### Example Schematic

The construction of this pressure relief device will require the following constituents for construction, as shown in FIG. 39;
1. Two T-pipe junction for each core
2. Connecting hydraulic line or piston for each core
3. Two one inch T pipe junction to piston housing connection device for each core
4. Possible Sealant for treaded connections of T-joint
5. Piston seals for each head

The hydraulic line/piston mechanism disclosed in this document is a viable solution to the pressure pulse issue. The concept can successfully “exchange” volume between cores, alleviating any pressure variation. The mechanism, however, does have some draw backs. These include the variation of the piston geometry due to the order in which the cores are arranged in series, as well as the issue of compounding friction.

### Mechanical Volume Exchange Embodiment

As discussed previously, with reference to FIG. 1, the pulsing issue arises from a volumetric change caused by the movement of the working piston in the system cores. During the operation of these cores a working fluid is passed over SMA bundles. This fluid is sequentially altered between hot and cold flows, and induces a phase change in the SMA components. When heated, the SMA component contracts, lifting the connected piston and thereby causing a reduction of volume in the system.

### Pressure Relief Operation

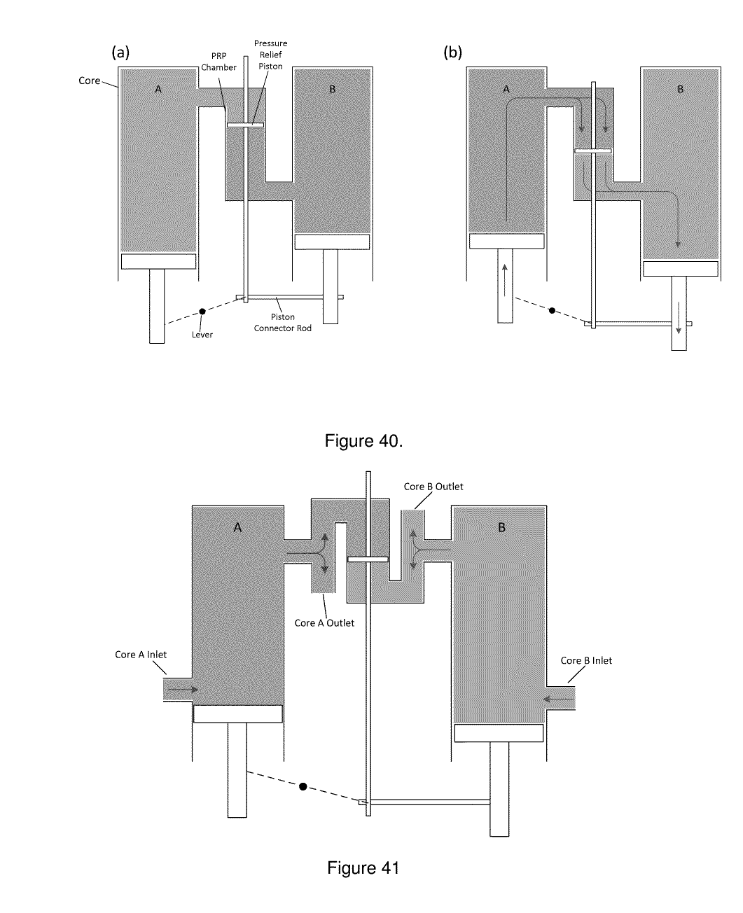

This method of pressure relief would operate by maintaining a constant volume in each core through a piston connection between cores. The movement of this piston or pistons will be governed by a mechanical linkage between it and the working piston. An example of such an arrangement is shown below in FIG. 40.

As can be seen above, as core A heats, its respective piston rises. Were the pressure relief mechanism not in place, this would result in a decrease in volume. However, this does not occur, as the Pressure Relief Piston (PRP) lowers as the main piston in core A rises, thereby maintaining a constant volume and pressure in this core. This is due to the lever connection, which will cause the PRP to move in the opposite direction of the working piston in core A, while the opposite is true of the working piston in core B. As the PRP is forced downward by the rising of the working piston in core A, in addition increasing the volume of this core, it also reduces the volume in the cooling core B, thereby offsetting the volumetric increase caused by the lowering piston contained therein. This operation is then reversed when the previously cooling core B begins heating, and A begins cooling. The rising working piston will cause the PRP to rise as well, due to the direct mechanical connecting rod. This will maintain a constant volume in this core as well as core A. The requirement of a central piston rod which runs through the entire PRP chamber is that the piston head must have an equal Cross Sectional Area (CSA) on both sides, as it must displace the same volume on either side during its stroke.

While not explicitly displayed above, the locations at which the pressure relief line connects to the cores will be intended to be placed at core outlets. In one embodiment these outlets are located at the distal end of the core with respect to the working piston. Hence the actual appearance of the concept may take the form shown in FIG. 41.

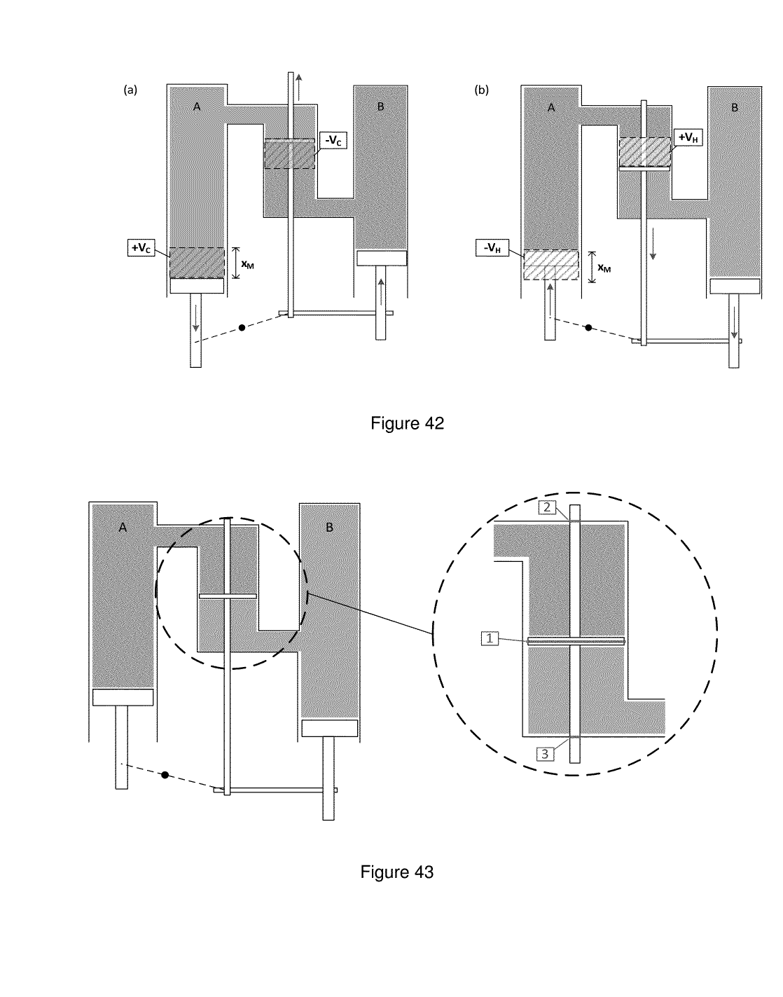

In order for this concept to operate correctly, the PRP must displace the correct volume of fluid. This volume will have to be of equal magnitude as that displaced by the main working piston. Due to the suggested arrangement shown in FIGS. 40 and 41, the PRP must displace said volume over the same stroke as the main piston. This is because the mechanical connections offer a 1:1 displacement transmission from the working piston to the PRP. FIG. 42 below highlights the volumetric displacements which occur during the operation of this pressure relief device.

As can be seen from FIG. 41 above, the volumetric displacements which are caused by the main piston (V_{M}) and the PRP (V_{P}) will cancel each other out if the PRP is sized appropriately. The PRP will be seized correctly if the following relationship is true;

V_{M}=V_{P}

Considering this relationship, the following procedure may be followed in order to define a suitable piston size.
1. Determine the volume displaced by the main piston over its stroke (x_{M}) using the formula for the volume of a cylinder, where A_{M} is its face surface area;

V_{M}=A_{M}x_{M}
2. Using this value, determine the required face surface area of the PRP (A_{P}) to displace this volume, considering it will have the same stroke as the main piston;

$${A}_{P} {x}_{M} = {V}_{M}$$

$${A}_{P} = \frac{{V}_{M}}{{x}_{M}}$$

3. Determine the required PRP diameter to displace the correct volume, while accounting for the fact that the piston rod which travels the length of the piston head's chamber will not contribute to any volumetric displacements, and hence must be considered in the PRP design. The PRP head must be sized to have a total surface area (A_{T}) which will displace the desired volume in addition to the CSA of the piston rod (A_{R});

$${A}_{T} = {A}_{P} + {A}_{R}$$

$$\frac{π {d}_{T}^{2}}{4} = \frac{{V}_{M}}{{x}_{P}} + \frac{π {d}_{R}^{2}}{4}$$

$${d}_{T} = \sqrt{\frac{4 {V}_{M}}{π {x}_{P}} + {d}_{R}}$$

Where d_{R} is the diameter of the piston rod.

Therefore it can be said that, using the above procedure, it is possible to specify an appropriately sized PRP head based on the geometries of the main piston.

### System Losses Analysis

The implementation of this pressure relief concept involves the addition of pistons to the system, and hence additional sources of friction and associated losses. More specifically, these sources of friction are found to originate from the surface contact of the seals and their metal housing. For the proposed concept, there will be three additional seals required in the system; one for the piston head (1), and two for the piston rod's entry and exit locations (2 and 3 respectively). These locations are shown in FIG. 43.

The work required to move these PRPs is performed by the working pistons of both cores simultaneously. Therefore, the operation of the pressure relief mechanism represents a leach of the power output of the system. This loss may be quantified partially by the presence of these frictional resistant forces. The friction associated with the seals will oppose the movement of the piston in both directions, and hence will always be present. Considering this, The net output force (Fₙₑₜ) from the working pistons after the frictional losses caused by the rod seals (Fᵣ) and the piston seals (F_{P}) have been deducted from the total output (F_{T}) can be expressed as follows;

Fₙₑₜ=F_{T}−F_{P}−2Fᵣ=F_{T}−F_{friction}

In addition to these frictional losses on the power output, there are also those associated with the force exerted when the main piston must lift the pressure relief components. These components consist of the weight applied to the working pistons by the piston head (m_{head}), the piston rod (m_{rod}), the hinge link (m_{hinge}), and the piston connector rod (m_{conn}). The losses on the working piston output can now be expressed by the following equation, where g is acceleration due to gravity;

Fₙₑₜ=F_{T}−F_{friction}−(m_{head}+m_{rod}+m_{hinge}+m_{conn})g

Fₙₑₜ=F_{T}−F_{friction}−F_{weight}

Finally, there may also be a weight acting against the pistons associated with the column of water which it must lift in order for said fluid to occupy the PRP chamber. This mass of fluid may be insignificant when compared to the overall volume contained within the system. The volume of water which the working pistons may have to lift can be seen as V_{H} during heating for core A, and V_{C} during heating for core B in FIG. 42. Similar to the equations above, the weight of these columns of water (m_{water}) can be represented as a loss to the net force production of the working pistons;

Fₙₑₜ=F_{T}−F_{friction}−F_{weight}−(m_{water})g

Fₙₑₜ=F_{T}−F_{friction}−F_{weight}−F_{water}

### Example Schematic

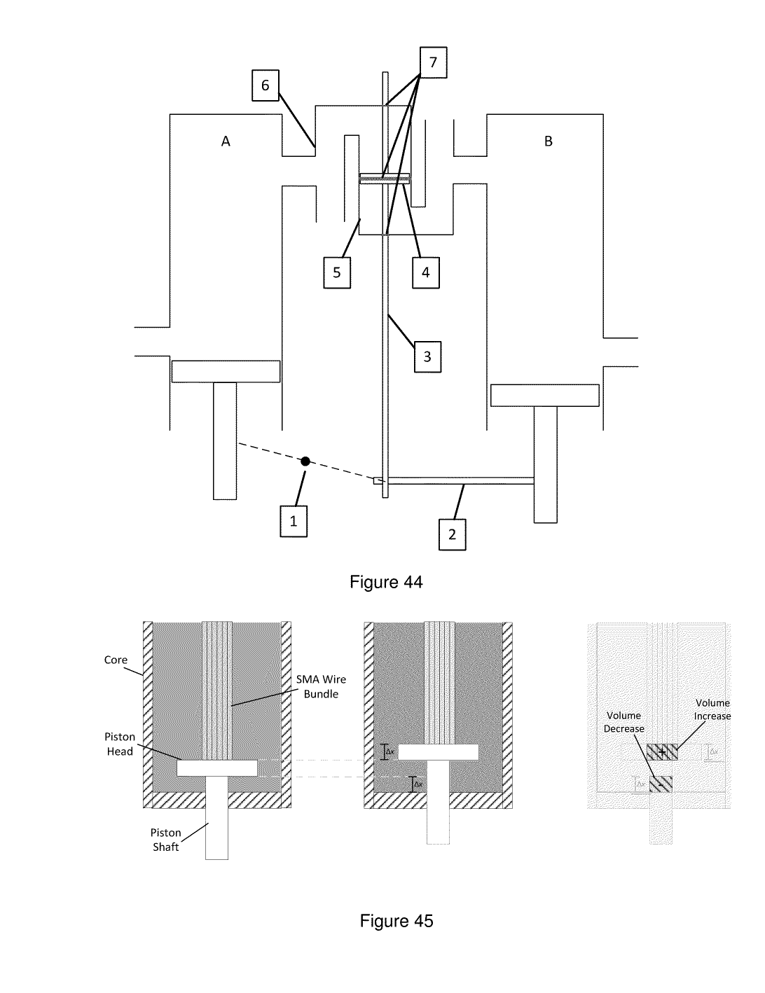

FIG. 44 illustrates a schematic of the concept discussed in this section.

The concept may require, but is not limited to, the following constituents;
1. Hinge joint per two adjoining cores
2. Piston connecting rod per two adjoining cores
3. Piston rod per two adjoining cores
4. Piston head per two adjoining cores
5. PRP chamber per two adjoining cores
6. T-joint piping per core
7. Three piston seals per core, two rod seals and one piston seal

### Piston Shaft Pressure Relief Embodiment

The invention disclosed offers a solution to pressure pulse problem outlined above and with reference to FIG. 1. This is achieved by matching the magnitude of the volumetric decrease caused by the introduction of the piston shaft into the system with that of the volumetric increase caused by the contraction of the SMA wire.

During the operation of the SMA cores a working fluid is passed over SMA bundles. This fluid is sequentially altered between hot and cold flows, and induces phase changes in the SMA components. When heated, the SMA components contract, lifting the connected piston and thereby causing a reduction of volume in the system.

The invention would be realised by designing the piston with respect to the SMA wires. During operation of the cores, there are both increases and reductions in volume. Specifically, the contraction of the SMA wires will cause an increase in volume, and the rising piston shaft will cause a decrease in volume. Therefore, it is possible to devise a system which is designed in such a way that these positive and negative volume changes cancel each other out, and hence allow the system to remain at a constant volume. FIG. 45 illustrates these volume changes.

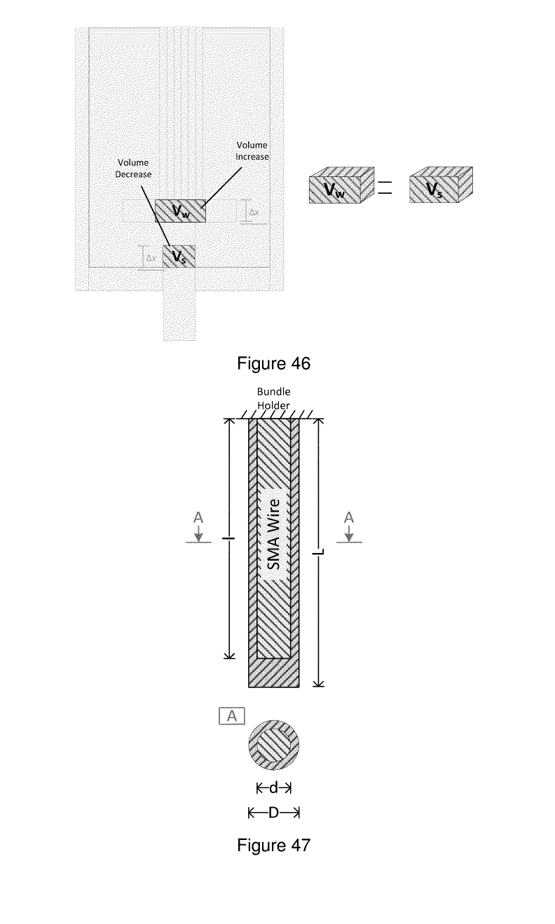

In one embodiment the invention provides a method of matching these volumes by designing the piston so that its shaft has a same Cross Sectional Area (CSA) that will displace the same combined volume of the linear and radial contractions of the SMA over the length of its stroke (which is equal to the displacement caused by the linear contraction of the SMA wire). This concept is shown in FIG. 46, where the volume displaced by the SMA wires (V_{w}) is equal to that displaced by the piston shaft (Vₛ).

### Design Calculations

The contraction undergone by the SMA wire is caused by the Bain strain. This results in the wire contracting in all directions. In the case of a wire the contractions occur linearly and radially. This is shown in FIG. 47, where the wire length reduces from L to I, and the diameter reduces from D to d.

In order to determine the correct diameter of the piston shaft, the following procedure should be followed:
1. Determine the volumetric change caused by the linear contraction of the SMA.
   a. Define the initial Cross Sectional Area (CSA), A₁, of each individual wire;

$${A}_{1} = \frac{π {D}^{2}}{4}$$

Where D=Diameter of wire before contraction.
   b. Calculate the volume displaced by linear contraction, V₁;

V₁=A₁(L−l)
Where L=Length of SMA wire before contraction, and l=Length of SMA wire after contraction.
2. Determine the volume displaced by radial contraction.
   c. Find the CSA of the radial contraction, A₂, which is seen to be the difference in the GSA's of the wire initially and after contraction;

$${A}_{2} = \frac{π {D}^{2}}{4} - \frac{π {d}^{2}}{4} = \frac{π {D}^{2} - π {d}^{2}}{4}$$

Where d=diameter after contraction.
   d. Calculate the volume displaced by radial contract, V₂;

V₂=A₂l
3. Determine the total volumetric reduction of the SMA wires, V_{T}.

V_{T}=(V₁+V₂)N
Where N=Number of SMA wires in bundle
4. Determine the required piston shaft diameter, dₛ, based on the total volume displaced by SMA wires.

$$\frac{π {d}_{s}^{2}}{4} ( L - l ) = {V}_{T}$$

$${d}_{s} = \sqrt{\frac{4 {V}_{T}}{π ( L - l )}} = 2 \sqrt{\frac{{V}_{T}}{π ( L - l )}}$$

As can be seen from above, it is possible to specify a piston shaft diameter based on the number of SMA wires and their diameters. It can also be seen that as the diameter of the shaft is a function of the volumes displaced by both the linear and radial contraction, as well as its available stroke being the same as the displacement caused by the linear contraction, the CSA of this shaft must be larger than that of the SMA wires combined;

$$\frac{π {d}_{s}^{2}}{4} = {A}_{s}$$

$${A}_{s} > {A}_{1}$$

### Stress Analysis

In order to ensure that the newly designed piston can withstand operational forces, a stress analysis must be performed. The piston shaft must be strong enough to transmit the force created by the contraction of the SMA wire to the transmission. This is a tensile force and, hence, must not exceed the yield strength of either the SMA or the piston material. The allowable stress on the SMA wires is a function of the desired fatigue life. For this reason, the stress acting on the SMA wires will be significantly less than its yield strength. In the core arrangement discussed in this section, the SMA wires and piston are connected in series. Due to this, they will both undergo the same forces. In fact, as is stated previously, the CSA of the piston shaft will be larger than the collective CSA of the SMA wires. Therefore, as long as the allowable stress present in the SMA wires does not exceed the yield strength of the piston material, the components will not fail within a factor of safety.

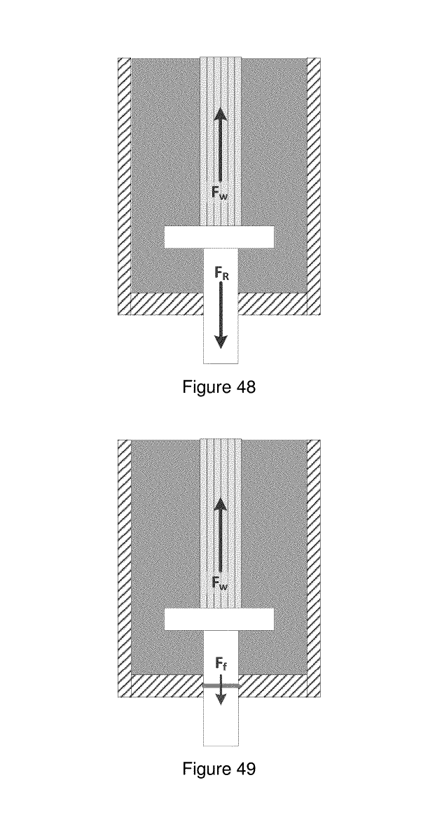

The stress undergone by a material is dependent upon its geometry and the force applied to it. The stress experienced by the wires and piston will be a function of these component's CSAs. As mentioned previously, due to the constraint placed on the system by the proposed pressure relief method, the SMA wires will have a CSA less than that of the piston shaft. The force which will induce stress within the wires and piston will be caused by the contraction of the SMA (F_{w}) and the resistance of the transmission to movement (F_{R}). This is illustrated in FIG. 48. The stress experienced across a geometry can be found using the following equation;

$$σ = \frac{F}{A}$$

Where F=Force and A=Area

During the operation of the core, the force felt across the power producing components will be constant at any given time. The variable in the system is the CSA of these components. As can be seen from FIG. 48 above, the piston head diameter may be greater than the piston shaft in order to accommodate an ideal arrangement of the SMA wires. Therefore, throughout the system, the wires would experience the largest stress, the piston shaft will experience a lesser stress, while the piston head would experience the least stress, due to its larger CSA. This can be represented mathematically as shown below.

$${σ}_{wires} = \frac{F}{{A}_{wires}}$$

$${σ}_{shaft} = \frac{F}{{A}_{shaft}}$$

$${σ}_{head} = \frac{F}{{A}_{head}}$$

$${A}_{head} > {A}_{shaft} > {A}_{wires} \\ ∴ {σ}_{head} < {σ}_{shaft} < {σ}_{wires}$$

### Frictional Analysis

The operation of the piston in the core will produce a resistive frictional force, which will oppose the movement of the piston in any direction it attempts to traverse. This frictional force will occur at the contact between the piston seal and the piston housing wall. The magnitude of frictional forces created is proportional to the contact area between these two boundaries. Due to the arrangement disclosed in this document, that being a free piston format, this means that the frictional force should be reduced.

In the conventional core arrangement is to place the seal on the main piston head, where the piston head is of a larger diameter than its shaft. In the free piston format the seal will be placed on the shaft, which has a smaller circumference, and hence less contact surface. The location of the frictional force, F_{f}, which acts within the core, is shown in FIG. 49.

### Required Components

The mechanism discussed in this section requires the following constituents, in addition to those already present within the core (piston):

1. Raw material to construct component

### 2. Machining

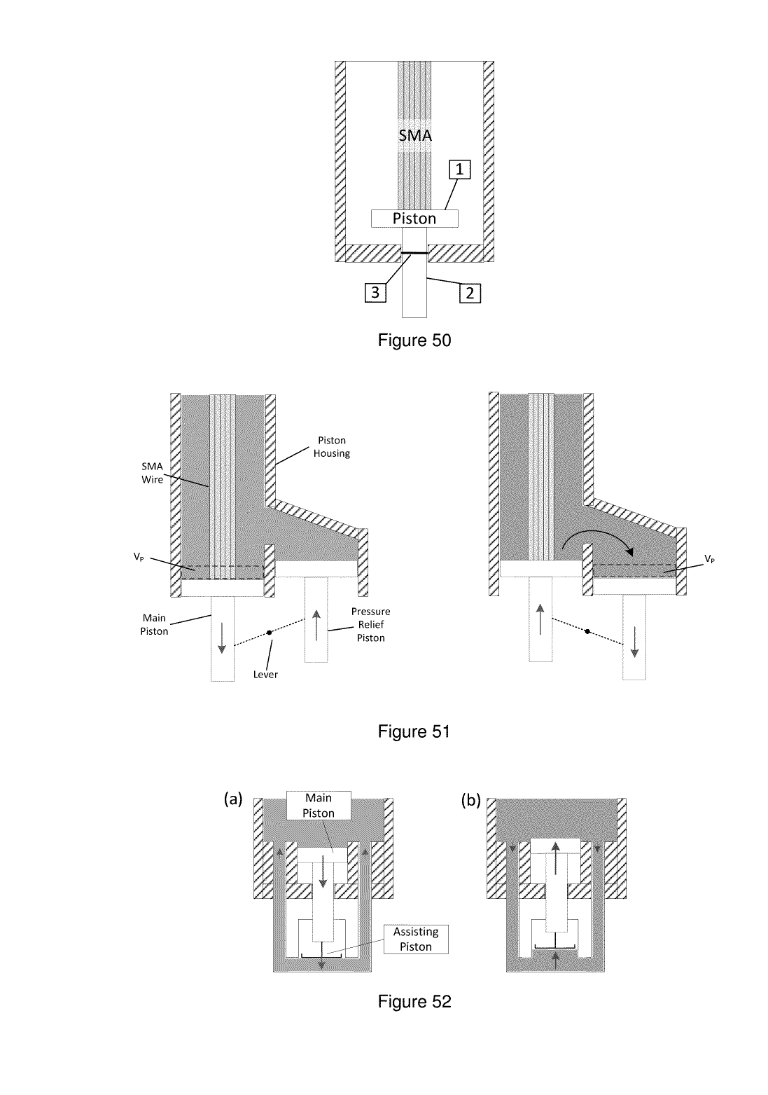

3. Seals—These will be located at the shaft of the piston, which will be a calculated diameter and hence may require procurement of custom made seals, as illustrated in FIG. 50

Advantages
The advantages of this pressure relief mechanism are as follows;
   Requires no additional components
   Possibly reduces friction due to free piston arrangement
   Simple to implement
   Uses mechanisms and assemblies already being implemented
   Free piston reduces overall volumetric displacement caused by piston (as opposed to piston head)

The pressure relief method of piston shaft design is a viable concept for removing the pressure pulse issue. It will allow a balance of volumetric alterations between the additional mass added to the system by the piston, and that removed by the SMA contraction. The concept can be implemented very easily, requiring little alterations to be made to the core.

### Mechanical Pressure Relief Embodiment

In another embodiment the pressure pulse problem may be solved through the use of altering the design of the Piston Housing (PH) or surrounding components by mechanical connections. Appropriate alterations would allow for mass to be moved about the core in such a way which would ensure a constant volume, thereby eliminating the pressure pulse.

The use of mechanical linkages to operate the pressure relief mechanism will remove issues associated with other methods which are dependent upon the pressure pulse to operate them. This technique of hydraulic pressure relief results in the pulse being shared between the pressure relief mechanism and other pressure vessels in the system, which may not be equipped to handle relatively rapid pressure fluctuations. Mechanically linked pressure relief devices will not allow this to occur, by maintaining a constant volume within the cores at all times.

In its most basic embodiment, this method of pressure relief would consist of an additional piston mechanically linked to the working piston. This piston would have similar dimensions as the working piston, and will operate out of sync. A suggested mechanism to allow for the pressure relief piston to perform opposite strokes to the main piston is a lever, with a displacement 1:1 ratio. This arrangement is shown FIG. 51.

It can be seen from FIG. 51 above that as the core heats causing the main piston to rise, the linked pressure relief piston lowers at an equal rate. This allows for the volume decrease caused by the rising piston (V_{P}), to be cancelled out by the pressure relief piston which will accept the displaced fluid. This will result in a constant volume being present in the core, and hence no pressure fluctuations.

### Embodiment A

### Self Assisting Piston

A self-assisting main piston is another embodiment of a PH design which eliminates the pressure pulse problem. This concept consists of a hydraulic line which travels from the main core to beneath the main piston, where there is a piston head of appropriate Cross Sectional Area (CSA) mechanically linked to said main piston. This arrangement will result in the volumetric decrease caused by the rising piston to be counter-acted by the equal volumetric increase that is now caused below it and vice versa. This operation is illustrated in FIG. 52, where the working fluid is permitted to travel beneath the main piston.

It can be seen from FIG. 52 above that as the main piston descends during cooling, the piston below it lowers, permitting a volumetric exchange between the main core and the area below the main piston. The opposite occurs during the heating cycle, and hence, the core should experience no volumetric fluctuations. This will result in much greater freedom of movement for the main piston, while also removing the pressure pulsing issue.

### General Design Considerations

A significant design consideration for this concept is the assisting piston. The face surface area of this component must be of a value such that it will displace a volume equal to that of the main piston head. This is due to the fact that the main piston and the assisting piston heads are fixed to one another. Therefore they have the same available stroke. Hence, whatever displacement one side undergoes so must the other. Specifying the correct face surface area of the assisting piston by means of its diameter may be achieved by considering various factors. This will be performed by determining the volume displaced by the main piston head after considering the effect of the SMA contraction. The SMA wires will contract both axially and radially which will result in an increase in the system volume. This volumetric change will counteract the volumetric decrease caused by a rising main piston. A procedure for determining the correct assisting piston size is outlined below.

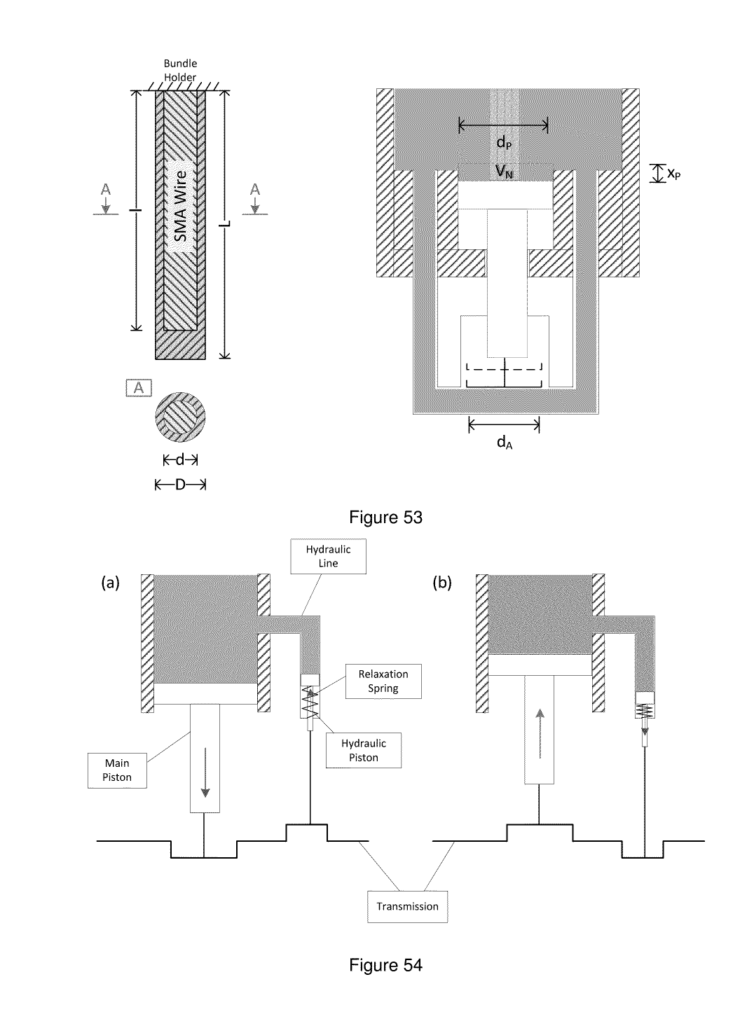

The contraction undergone by the SMA wire is caused by the Bain strain. This results in the wire contracting in all directions. In the case of a wire the contractions occur linearly and radially. This is shown in FIG. 53, where the wire length reduces from L to I, and the diameter reduces from D to d. The basic geometries of the piston housing mechanisms are also shown in this figure.

In order to determine the correct diameter of the piston shaft, the following procedure should be followed:
1. Determine the volumetric change caused by the linear contraction of the SMA.
   e. Define the initial CSA, A₁, of each individual wire;

$${A}_{1} = \frac{π {D}^{2}}{4}$$

Where D=Diameter of wire before contraction.
   f. Calculate the volume displaced by linear contraction, V₁;

V₁=A₁(L−l)
Where L=Length of SMA wire before contraction, and l=Length of SMA wire after contraction.
2. Determine the volume displaced by radial contraction.
   g. Find the CSA of the radial contraction, A₂, which is seen to be the difference in the GSA's of the wire before and after contraction;

$${A}_{2} = \frac{π {D}^{2}}{4} - \frac{π {d}^{2}}{4} = \frac{π {D}^{2} - π {d}^{2}}{4}$$

Where d=diameter after contraction.
   h. Calculate the volume displaced by radial contract, V₂;

V₂=A₂l
3. Determine the total volumetric reduction of the SMA wires, V_{T}.

V_{T}=(V₁+V₂)N
Where N=Number of SMA wires in bundle
4. Calculate the volume displaced by main piston.
   a. Determine volume displaced over a stroke, x_{P};

$${V}_{M} = {A}_{P} {x}_{P} = \frac{π {d}_{P}^{2}}{4} {x}_{P}$$

Where Aₚ=face surface area of the a min piston, and d_{P}=diameter of the main piston head.
   b. Determine actual volume, V_{N}, displaced by main piston, accounting for volumetric offset caused by SMA contraction;

V_{N}=V_{M}−V_{T}
5. Define appropriate assisting piston head diameter based on required volume to be displaced per stroke, V_{A}.

$${V}_{A} = {V}_{N} = {A}_{A} {x}_{P}$$

$${A}_{A} = \frac{{V}_{N}}{{x}_{P}}$$

$$\frac{π {d}_{A}^{2}}{4} = \frac{{V}_{N}}{{x}_{P}}$$

$${d}_{A} = 2 \sqrt{\frac{{V}_{N}}{{x}_{P} π}}$$

Where A_{A}=Face area of assisting piston, and d_{A}=Diameter of assisting piston head.

### Concept B—Transmission Assisted

There are various different embodiments which the concept discussed in this document could take. One such arrangement is one in which the pressure pulse is alleviated by a piston connected to the transmission. This concept is illustrated in FIG. 54. Due to the fact that the transmission shaft to which the pressure pulse piston is connected will have a unidirectional movement, this piston will require a return spring, in order to move the piston back to its original position.

As can be seen from the figure above, as the core heats and its piston rises, the force created pulls the hydraulic piston downwards through the transmission, and thereby increasing the volume of the system by the appropriate amount. This operation will lead to constant volume present in the core, and hence no pressure pulses. As the core cools, the opposite operation occurs, where the main piston lowers, and the hydraulic pressure relief piston rises due to the presence of the return spring once again maintaining a constant pressure.

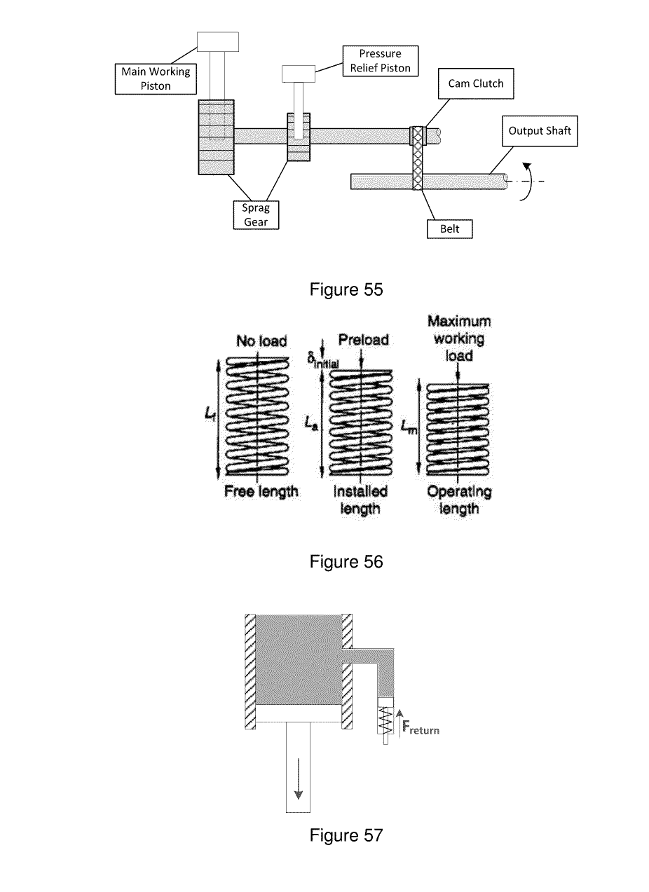

It should be noted that the hydraulic piston is only acted on by the main piston when the core is heating. When the core is being cooled, the connected transmission component, such as a sprag gear, will freewheel. This will allow for the pressure relief piston to return to its original position, through the use of a return spring. The connection from the pressure relief piston to the transmission can be said to be a duplicate of the transmission used for the main piston, except they will be mounted on opposite sides of the transmission shaft, and may be sized differently. This will allow for work to be transferred to the pressure relief piston in the opposite direction to the main piston, in order to satisfy a constant volume present in the core. In the same vein, this will allow for both sprags to freewheel in opposite directions. This arrangement is shown below in FIG. 55.

As can be seen from the above diagram, the transmission consists of a sprag gear, a cam clutch, a belt, and two shafts. The purpose of the sprag gear is to allow work to be transmitted to its mated shaft in one direction (when the pressure pulse occurs), and to freewheel in the other direction. This results in work being transmitted only when the core is heating, or when the working piston is rising. The cam clutch is implemented in order to allow transmission of work from the sprag gear shaft to the output shaft, but not the other way around. This allows multiple sources to provide power to the shaft without affecting each other.

The stroke of each pressure relief piston can be altered by designing its piston face appropriately, as discussed previously in this document. The stroke imposed on the pressure relief pistons will affect the required gear size to be used on the output shaft, in order to allow for the required stroke to be transmitted from the working piston, which will have a fixed displacement. For example, if the required pressure relief stroke was required to be longer than the power stroke of the working piston, its mated gear would need to be bigger than that connected to said working piston. The opposite is true if the stroke of the pressure relief piston was shorter than that of the main piston.

Due to the arrangement consisting of the working piston being linked to the pressure relief piston, there will be work leached off the system/working piston during its power stroke (up stroke). The force which will be required to operate the pressure relief piston will need to overcome the relaxation force of the return spring. Therefore, in order to determine this force, the desired spring must be defined.

In terms of designing the device, consideration must be given to the piston face surface area, and also to the rigidity and geometries of the spring. It has already been discussed how one could size the pressure relief piston based on its allowable deflection. This allowable deflection could be dictated by available space around the cores, if the device were to protrude from said cores. The opposite may be true for the piston face size being constrained by the geometry of the core or standard available parts, in which case the resulting deflections will be calculated in a similar vein. Based off these values, the correct spring may be sized. FIG. 56 illustrates the states of a compression spring as it would appear in operation.

As can be seen in FIG. 56, the spring may appear in one of three states in different operations; free length, preloaded, and maximum working load. The free length is the length of the spring when unloaded, before the drive is switched on in this application. The installed length, or preload will be the length of the spring once the drive is turned on. This will be the state at which the spring will be observed to be in when the system is brought up to operational pressure (≈2 Bar). Finally, under the maximum working load, or the pressure pulse, the spring will reduce to its operational length. This is the length at which the main piston will reach its peak during heating of the SMA, and the imposed deflection will be at a maximum (i.e. continual deflection from that caused by initial 2bar). Therefore it can be concluded that the total deflection the spring must be capable of facilitating the deflection caused by the initial 2 Bar condition in addition to that caused by the attached transmission which will alleviate the pressure pulse. This can be determined mathematically as follows.

Using Hooke's Law it is possible to define the required spring constant which would be used to define the spring which would allow the required overall deflection which it must undergo. Hooke's Law can be expressed via the equation, where F is force, k is the spring constant, and x is displacement;

F=−kx

Since the primary function of the spring will be to displace a specific volume based on its piston face surface area, it is necessary determine the correct value for the spring constant (k) and spring size which will perform as required. This can be achieved through the example which follows.

Begin by selecting an off the shelf spring, with appropriate dimensions. An example of such a spring is a LHC 250U 08M compression spring as supplied by leesprings.com. This spring has a relatively high spring constant (18.87 N/mm) as well as a relatively high stroke length (70.8 mm). The appropriateness of this spring can be examined as shown below.

The total available stroke for this spring, S_{T}, is 70.8 mm, however the allowable stroke will be less as over compressing a spring can damage its performance under cyclic loading. Therefore the actual available stroke, S_{A}, can be expressed as;

S_{A}=(0.85)S_{T}

S_{A}=(0.85)(70.8)=60.18 mm

The next step is to determine the initial displacement caused by system pressure, Pᵢ, of 2 Bar (200 kPa). For simplicity, the volumetric increase caused by the SMA wires will be neglected in this example. It will be assumed that the pressure relief piston will be designed to have the same piston head diameter as the main piston in order for it to displace the same amount of volume over the same stroke, so that the same sprag gears may be used for both pistons. The diameter of the main piston head can be 60 mm. Taking these system parameters into consideration, the force exerted on the pressure relief piston, Fᵢ, can be determined as follows, where A is the piston face area of the pressure relief piston.

$${P}_{i} = \frac{{F}_{i}}{A}$$

$${F}_{i} = {P}_{i} A = ( 200 , 000 ) ( \frac{π {0.06}^{2}}{4} )$$

$${F}_{i} = 565.5 N$$

This force can now be input to Hooke's law in order to determine the initial deflection of the relaxation spring, xᵢ;

$${F}_{i} = - {kx}_{i}$$

$${x}_{i} = \frac{{F}_{i}}{k} = \frac{565.5}{18.87} = 29.97 mm$$

The stroke of the main piston, and hence the pressure relief piston in this example, during SMA contraction will be 30 mm. Therefore the total deflection, x_{f}, which the spring will undergo, will be;

x_{f}=xᵢ+x_{d}=29.97+30≅60 mm

∴x_{f}<S_{A}

Therefore, it can be said that this spring will be appropriate for this application, as it is capable of undergoing the required deflections within a cyclic range, as the operational stroke, x_{f}, is less than the available stroke, S_{A}.

The final step is to determine the return force, Fᵣₑₜᵤᵣₙ, that will be required to return the piston back to its original position. This is achieved by once again using Hooke's law. The location of this force is also shown in FIG. 57.

$${F}_{return} = - {kx}_{d}$$

$${F}_{return} = ( 18.87 ) ( 30 ) [ \frac{N}{mm} \cdot mm ]$$

$${F}_{return} = 566.1 N$$

Hence, for this application, the pressure relief piston will take 566 Newtons of force away from each power stroke of the main working piston.

### Example Schematics

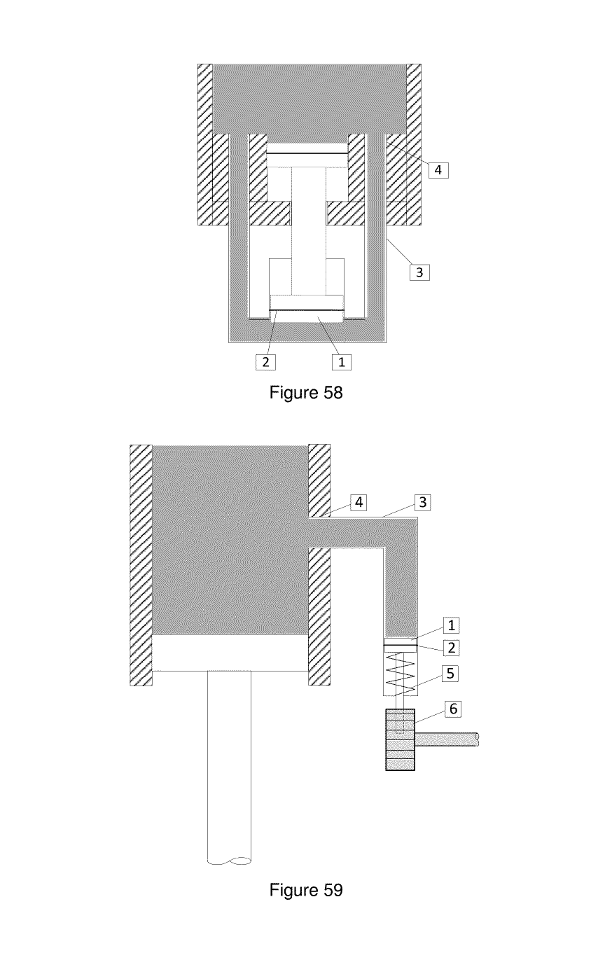

The construction of these pressure relief devices may require but are not restricted to the following constituents, as seen in FIGS. 58, 59, and 60.

### Example A

### FIG. 58

1. Assisting piston per core
2. Assisting piston seal per core
3. Fluid line for connecting core to assisting piston per core
4. PH machining

### Example B

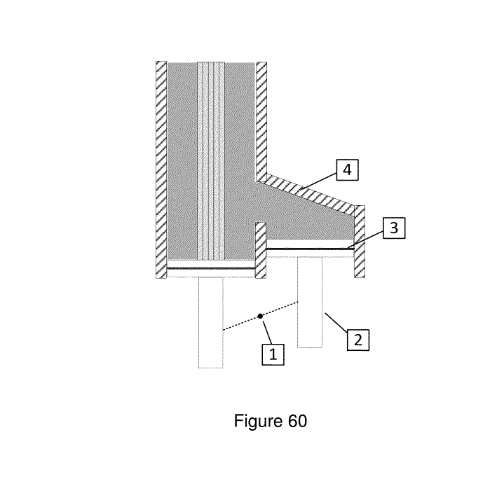

### FIG. 59

1. Pressure relief piston per core
2. Seals per pressure relief piston
3. Hydraulic line to connect core to piston per core
4. PH machining to allow connection point
5. Return Spring per core
6. Additional sprag gear per core

### Example C

### Basic Lever Embodiment FIG. 60

1. Connecting lever arm between main piston and pressure relief piston
2. Pressure relief piston
3. Pressure relief piston seal
4. PH machining or addition pressure relief piston housing component

The piston housing pressure relief mechanisms disclosed in this document are viable solutions to the pressure pulse issue. These concepts can successfully relocate volumes of fluid to different regions of their cores. The mechanisms, however, may require a larger quantity of machining and components when compared with other solutions such as connecting adjacent cores or altering the piston shaft.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. An energy recovery device comprising:
a first SMA core housed in a first immersion chamber and adapted to be sequentially filled with fluid to allow heating and/or cooling of the first SMA core;
a second SMA core housed in a second immersion chamber and adapted to be sequentially filled with fluid to allow heating and/or cooling of the second SMA core; and
wherein the first core and second core are in fluid communication with each other, such that a substantially constant pressure is maintained in the energy recovery device.

2. The energy recovery device of claim 1 wherein the first and second cores are in fluid communication via a regenerative heat exchanger.

3. The energy recovery device of claim 1 wherein the first and second cores are in fluid communication via an adjoining piston or hydraulic line.

4. The energy recovery device of claim 1 wherein a constant volume in each core is maintained through a piston connection between the first and second cores.

5. The energy recovery device of claim 1 wherein the first or second SMA core is linked with a moveable piston in the chamber; wherein the piston is configured with a shaft that has a substantially same Cross Sectional Area (CSA) that will displace the same combined volume of the linear and/or radial contractions of the SMA core over the length of one expansion or contraction.

6. The energy recovery device of claim 1 wherein the first or second SMA core is linked with a moveable first piston in the chamber; and a second piston is adapted to operate in a non-synchronous manner with the first piston.

7. The energy recovery device of claim 1 the first or second immersion chamber is configured with an additional chamber comprising a biasing element, such as a spring, wherein on the SMA core expanding in said chamber the biasing element allows fluid to flow into the additional chamber.

8. The energy recovery device of claim 7 wherein the biasing element comprises a hydraulic piston.

9. An energy recovery device comprising:
a SMA core housed in an immersion chamber and adapted to be sequentially filled with fluid to allow heating and/or cooling of the SMA core; and
the immersion chamber is configured with an additional chamber comprising a biasing element, such as a spring, wherein on the SMA core expanding in said chamber the biasing element allows fluid to flow into the additional chamber.

10. The energy recovery device of claim 9 wherein the biasing element comprises a hydraulic piston.
